(19) United States
(12) Patent Application Publication
(10) Pub. No.: US 2026/0229540 A1
(43) Pub. Date: Aug. 6, 2026

(54) MAGNESIUM-ALLOY CURRENT COLLECTORS FOR LITHIUM-ION BATTERIES, AND METHODS FOR MAKING AND USING THE SAME

(71) Applicant: Khemia Metals Inc., Oakland, CA (US)

(72) Inventors: Helen K. BERGSTROM, Berkeley, CA (US); Brian E. HARDIN, San Carlos, CA (US); Daniel H. SUZUKI, Oakland, CA (US); Fatima M. YOUSUF, Oakland, CA (US); Louie ZHONG, Belmont, CA (US)

(21) Appl. No.: 19/465,686

(22) Filed: Jan. 30, 2026

Related U.S. Application Data
(60) Provisional application No. 63/754,269, filed on Feb. 5, 2025.

(51) Int. Cl. H01M 4/66; H01M 10/0525

(52) U.S. Cl. CPC H01M 4/662; H01M 10/0525

(57) ABSTRACT

The disclosed technology utilizes magnesium alloys in current collectors for lithium-ion batteries. Some variations provide a lithium-ion battery comprising: a negative electrode; a negative-electrode current collector in contact with the negative electrode; a lithium-containing electrolyte; a separator interposed between the negative electrode and the positive electrode, wherein the separator is permeable to lithium ions; a positive electrode (cathode); and a positive-electrode current collector in contact with the positive electrode, wherein the negative-electrode current collector comprises a magnesium alloy foil containing at least 50 atomic percent magnesium. Magnesium alloys may alternatively, or additionally, be utilized as the positive-electrode current collector. The invention provides low-cost, lightweight current-collector materials that can be a drop-in replacement for existing lithium-ion-batteries and production processes, while maintaining mechanical, electrical, and electrochemical battery performance. Experimental data are presented to demonstrate the principles and utility of the invention across a range of magnesium alloys as well as pure magnesium.

### PRIORITY DATA

This patent application claims priority to U.S. Provisional Patent App No. 63/754,269, filed on Feb. 5, 2025, which is hereby incorporated by reference.

### FIELD

The present disclosure generally relates to lithium-ion batteries that incorporate a magnesium-alloy anode current collector.

### BACKGROUND

The push to electrify transportation will require the United States electric grid to double in capacity by 2050, assuming 186 million (two-thirds) of light-duty vehicles are converted to electrical energy rather than combustion engines. This shift will necessitate massive investments in new transmission lines and distribution systems that could reach over $1 trillion by 2050 when all 186 million light-duty electric vehicles (EVs) are in service. The electricity distribution system that connects to the EV charging station—including substations, circuits, switches, and transformers—will incur over 90% of this projected investment. Optimized EV charging and vehicle-to-grid integration can reduce the required distribution investments by ~70% or $600 billion by minimizing congestion at the distribution level, allowing two-way energy transfers, storing energy closer to the load, and integrating widely distributed renewables.

Lithium-ion batteries (LIBs), whether primary or secondary batteries, comprise metal foils, called current collectors, coated in active materials, a lithium-containing electrolyte, and a separator. The positive electrode (cathode) active material is a lithium and transition-metal-containing compound, such as lithium iron phosphate (LFP), lithium nickel manganese cobalt oxide (NMC), or lithium nickel cobalt aluminum oxide (NCA) deposited on a metal foil. A planar aluminum foil is conventionally used as the positive-electrode current collector. The negative electrode (anode) active material is typically graphite with 0-5 wt % silicon additives deposited on a metal foil. The negative-electrode current collector in most commercially available lithium-ion batteries is a planar copper foil, though titanium and stainless-steel foils have been commercialized as negative-electrode current collectors. Lithium-ion batteries also comprise a separator that is permeable to lithium ions and a lithium-containing electrolyte. All lithium-ion batteries use current collectors to transport charge through the cell and in many cases provide mechanical support for the active material.

Metallic current collectors are commonly selected for use in lithium-ion batteries because they are conductive, have adequate mechanical properties, can be welded to tabs, and/or are stable within the electrochemical window of a lithium-ion battery (i.e., the current collectors are essentially inactive materials). Metallic foils are generally required to be stable against continuous reaction with electrolyte species as well as against significant electrochemical alloying with lithium ions over the battery operating voltage window.

Copper foil is commonly used as the negative-electrode current collector because it is conductive, easy to produce at thin gauges of less than 15 microns, and does not electrochemically alloy with lithium in the negative electrode operating voltage window. Copper is not typically used as a positive electrode current collector because it has poor oxidative stability at positive electrode operating potentials.

Copper foil prices are based on the spot price of copper, which was between $10-12/kg in 2025 with a tolling charge (e.g., $6/kg) to convert to a foil. In 2025, battery-grade copper foil prices ranged from $12-18/kg. Roughly 9 m² of copper foil is required per kWh of automotive-grade LFP cells. In 2025, copper foil was the third-most expensive (~$10/kWh, ~20% of LFP cell cost) and third-heaviest component (~0.5 kg/kWh for LFP cells) in lithium-ion batteries. Copper demand is increasing because the metal is widely used in EVs as well as renewable energy (e.g., solar and wind), energy storage, and the electrical-grid infrastructure. A standard 60 kWh LFP EV battery pack may contain 30 kg of copper foil, and the EV industry could create an additional 2.25 million tons/yr in copper demand—which would be 10% of current Cu production.

There is a need in the field of lithium-ion batteries to reduce the weight and cost of the battery by replacing copper foil as the negative-electrode current collector. To date, only three alternative non-copper-containing materials have been used for commercial negative-electrode current collectors: aluminum, stainless steel, and titanium. Aluminum is not used with graphite, silicon, or lithium metal active materials because the aluminum typically reacts with lithium at potentials below ~380 mV vs. Li⁰/Li⁺ during charging. Aluminum is typically only used with lithium titanate negative electrodes that operate at potentials above 1 V vs. Li⁰/Li⁺. Stainless steel is less expensive than copper, but the bulk resistivity of stainless steel is 25× higher than copper, and stainless steel has a relatively high density (7.5-8 g/cm³). Titanium is less dense (4.5 g/cm³) but more expensive ($30-40/kg), and has a bulk resistivity that is 11× greater than copper.

Aluminum foil is commonly used as the positive-electrode current collector because it is relatively inexpensive, conductive and has reasonable oxidative stability in LIB electrolytes. Aluminum foil is not typically used on the negative-electrode side, because aluminum can alloy with lithium at low potentials, causing 100% volume expansion and tears in the foil. This results in loss of active material and catastrophic cell failure including internal shorting.

In view of the state of the art, there is a need for low-cost, lightweight current-collector materials that can be a drop-in replacement for existing lithium-ion-batteries and production processes. It is desirable to maintain mechanical, electrical, and electrochemical battery performance using new current-collector materials. Ideally, the current-collector materials can be used as both negative-electrode current collectors as well as positive-electrode current collectors.

### SUMMARY

Some variations of the invention provide a lithium-ion battery comprising:
(a) a negative electrode (anode);
(b) a negative-electrode current collector in contact with the negative electrode;
(c) a lithium-containing electrolyte;
(d) a separator interposed between the negative electrode and the positive electrode, wherein the separator is permeable to lithium ions;
(e) a positive electrode (cathode); and
(f) a positive-electrode current collector in contact with the positive electrode,
wherein the negative-electrode current collector comprises a magnesium alloy foil containing at least 50 atomic percent magnesium.

In some embodiments, the negative-electrode current collector consists essentially of the magnesium alloy foil.

In some embodiments, the magnesium alloy foil has a thickness selected from about 4 μm to about 50 μm. In some embodiments, the magnesium alloy foil has an average roughness Rₐ selected from about 0.05 μm to about 2 μm. In some embodiments, the magnesium alloy foil has a root-mean-square roughness R_{q} selected from about 0.05 μm to about 3 μm. In some embodiments, the magnesium alloy foil has a surface roughness R_{z} selected from about 0.25 μm to about 3 μm.

In some embodiments, the magnesium alloy foil contains from 50 atomic percent magnesium to 99.8 atomic percent magnesium.

In some embodiments, the magnesium alloy foil further comprises aluminum, copper, lithium, manganese, zinc, calcium, zirconium, silver, yttrium, cerium, lanthanum, or a combination thereof. In certain embodiments, the magnesium alloy foil further comprises at least two of aluminum, copper, lithium, manganese, zinc, calcium, zirconium, silver, yttrium, cerium, and lanthanum.

In some embodiments, the magnesium alloy foil further comprises from about 0.25 to about 15 weight percent aluminum.

In some embodiments, the magnesium alloy foil further comprises from about 0.25 to about 10 weight percent zinc.

In some embodiments, the magnesium alloy foil further comprises from about 0.01 to about 5 weight percent manganese.

In some embodiments, the magnesium alloy foil further comprises from about 0.25 to about 10 weight percent calcium.

In some embodiments, the magnesium alloy foil further comprises from about 1 to about 20 weight percent lithium.

In some embodiments, the magnesium alloy foil further comprises from about 0.05 to about 10 weight percent copper.

In preferred embodiments, the negative-electrode current collector is substantially copper-free. In these embodiments, the lithium-ion battery may be substantially copper-free.

In some embodiments, the magnesium alloy foil contains a magnesium alloy selected from the group consisting of AJ52A, AJ62A, AM50A, AM60A, AM601B, AM100A, AMX602, AS41A, AZ31B, AZ31C, AZ31D, AZ61A, AZ63A, AZ63B, AZ63C, AZ63D, AZ80A, AZ81A, AZ91A, AZ91B, AZ91C, AZ91D, AZ91E, AZ92A, AZ101A, AZX111, AZX211, AZX311, K1A, LA21, LA41, LA61, LA91, LA141, LZ21, LZ41, LZ61, LZ91, LZ141, LAZ941, M1A, ZC63A, ZE41A, ZEK100, ZK40A, ZK51A, ZK60A, ZK61A, and combination thereof.

In certain embodiments, the magnesium alloy foil compositionally consists essentially of AJ52A, AJ62A, AM50A, AM60A, AM60B, AM100A, AMX602, AS41A, AZ31B, AZ31C, AZ31D, AZ61A, AZ63A, AZ63B, AZ63C, AZ63D, AZ80A, AZ81A, AZ91A, AZ91B, AZ91C, AZ91D, AZ91E, AZ92A, AZ101A, AZX111, AZX211, AZX311, K1A, LA21, LA41, LA61, LA91, LA141, LZ21, LZ41, LZ61, LZ91, LZ141, LAZ941, M1A, ZC63A, ZE41A, ZEK100, ZK40A, ZK51A, ZK60A, ZK61A, and combination thereof.

In some embodiments, the magnesium alloy foil is a rolled foil.

In some embodiments, the magnesium alloy foil has an areal capacity from about 2 to about 250 μAh/cm² at a foil thickness of about 4 μm to about 50 μm or less when biased at 20 mV vs Li⁰/Li⁺ for 12 hours.

In some embodiments, the magnesium alloy foil has a bulk electrical resistivity from about 5 to about 25 μΩ-cm.

In some embodiments, the magnesium alloy foil has an ultimate tensile strength greater than 150 MPa. The magnesium alloy foil may have an elongation to fracture greater than 0.5%.

The lithium-ion battery may comprise an electrode/separator stack containing the negative electrode, the separator, and the positive electrode. In some embodiments, the electrode/separator stack is wound. In some embodiments, the electrode/separator stack is folded. In some embodiments, the electrode/separator stack is flat.

In some embodiments, the negative-electrode current collector is joined to a conductive metal body via ultrasonic welding, laser welding, an adhesive, or a combination thereof. In some embodiments, the negative-electrode current collector is mechanically joined to a conductive metal body.

In some embodiments, the negative-electrode current collector is joined to a body material comprising an additional magnesium alloy (i.e., structurally different than the magnesium alloy in the negative-electrode current collector). The additional magnesium alloy, although it is a distinct structure, may be compositionally the same as the magnesium alloy foil.

In some embodiments, the negative-electrode current collector is joined to a body material comprising aluminum, an aluminum alloy, iron, steel, stainless steel, nickel, copper, zinc, a zinc alloy, or a combination thereof.

In some embodiments, the positive-electrode current collector comprises a second magnesium alloy foil, wherein the second magnesium alloy foil contains at least 50 atomic percent magnesium. In certain embodiments, the second magnesium alloy foil is compositionally the same as the magnesium alloy foil (in the negative-electrode current collector).

In some embodiments, the positive-electrode current collector comprises an aluminum or aluminum alloy foil.

Some embodiments provide a sealed lithium-ion battery comprising the lithium-ion battery as disclosed, wherein the sealed lithium-ion battery further comprises a battery casing that sealably encloses the lithium-ion battery from the environment. In some embodiments, the battery casing has a cylindrical form factor. In some embodiments, the battery casing has a rigid rectangular form factor. In some embodiments, the battery casing has a prismatic form factor. In some embodiments, the battery casing has a soft-pouch form factor.

In some embodiments of the lithium-ion battery, the negative electrode comprises graphite. In some embodiments, the negative electrode comprises graphite and silicon. In some embodiments, the negative electrode comprises a majority of silicon on a weight basis. In some embodiments, the negative electrode comprises lithium titanate. In some embodiments, the negative electrode comprises metallic lithium.

In some embodiments, the negative electrode further comprises an organic binder. The organic binder may be selected from the group consisting of carboxymethyl cellulose, styrene-butadiene rubber, polyacrylic acid, polyvinyl alcohol, polyethylene oxide, polyvinylidene fluoride, polytetrafluoroethylene, and mixtures thereof.

In some embodiments, the negative electrode further comprises a conductive additive selected from the group consisting of carbon black, single-walled carbon nanotubes, multi-walled carbon nanotubes, graphene, acetylene black, and mixtures thereof.

In certain embodiments, the negative electrode comprises from 0 to about 10 weight percent of the combined total of carbon black and polyvinylidene fluoride.

In certain embodiments, the negative electrode comprises from 0 to about 10 weight percent of the combined total of carboxymethyl cellulose and styrene butadiene rubber.

In some embodiments, the negative electrode material is mixed in a solvent and deposited onto the magnesium alloy foil. In some embodiments, the negative electrode material is mixed in an alkaline aqueous solution and deposited onto the magnesium alloy foil. In some embodiments, the negative electrode material is deposited via a dry process.

Generally, the electrolyte may be a liquid, a solid, a semi-solid, a gel, or a combination thereof.

In some embodiments of the lithium-ion battery, the electrolyte comprises a fluorine-containing compound. The electrolyte may contain from about 10 mM to about 6 M of the fluorine-containing compound, for example.

In some embodiments, the electrolyte comprises a material selected from the group consisting of lithium bis(trifluoromethansulfonyl)imide, lithium hexafluorophosphate, lithium bis(fluorosulfonyl)imide, lithium trifluoromethane sulfonate, lithium perchlorate, and combinations thereof.

In some embodiments, the electrolyte comprises ethylene carbonate, propylene carbonate, dimethyl carbonate, diethyl carbonate, ethyl methyl carbonate, fluoroethylene carbonate, 1,2-dimethoxyethane, 1,3-dioxolane, acetonitrile, ethyl acetate, tetrahydrofuran, polyethylene oxide, or a combination thereof.

In some embodiments, the electrolyte comprises fluoroethylene carbonate, vinylene carbonate, methylene ethylene carbonate, propane sultone, biphenyl, lithium bis(oxalato)borate, lithium difluoro(oxalato)borate, lithium bis(fluorosulfonyl)imide, or a combination thereof.

Some variations provide a lithium-ion battery comprising:
(a) a negative electrode;
(b) a negative-electrode current collector in contact with the negative electrode;
(c) a lithium-containing electrolyte;
(d) a separator interposed between the negative electrode and the positive electrode, wherein the separator is permeable to lithium ions;
(e) a positive electrode; and
(f) a positive-electrode current collector in contact with the positive electrode,
wherein the negative-electrode current collector comprises a foil consisting essentially of magnesium.

Other variations of the invention provide a lithium-ion-battery current collector for use in transferring electrical current to or from a negative electrode in a lithium-ion-battery, wherein the lithium-ion-battery current collector consists essentially of a magnesium alloy foil containing at least 50 atomic percent magnesium, wherein the lithium-ion-battery current collector is substantially copper-free, and wherein the magnesium alloy foil is characterized by:
(a) a thickness selected from about 4 μm to about 50 μm;
(b) an average roughness Rₐ selected from about 0.05 μm to about 2 μm;
(c) a root-mean-square roughness R_{q} selected from about 0.05 μm to about 3 μm;
(d) a surface roughness R_{z} selected from about 0.25 μm to about 3 μm;
(e) an areal capacity from about 2 to about 250 μAh/cm² when biased at 20 mV vs Li⁰/Li⁺ for 12 hours;
(f) a bulk electrical resistivity no greater than 25 μΩ-cm;
(g) an ultimate tensile strength greater than 150 MPa; and
(h) an elongation to fracture greater than 0.5%.

Some variations provide a lithium-ion battery in which a magnesium alloy is utilized at the positive electrode (cathode), wherein the lithium-ion battery comprises:
(a) a negative electrode;
(b) a negative-electrode current collector in contact with the negative electrode;
(c) a lithium-containing electrolyte;
(d) a separator interposed between the negative electrode and the positive electrode, wherein the separator is permeable to lithium ions;
(e) a positive electrode; and
(f) a positive-electrode current collector in contact with the positive electrode,
wherein the positive-electrode current collector comprises a magnesium alloy foil containing at least 50 atomic percent magnesium.

In some embodiments, the positive-electrode current collector consists essentially of the magnesium alloy foil.

In some embodiments, the magnesium alloy foil has a thickness selected from about 4 μm to about 50 μm. In some embodiments, the magnesium alloy foil has an average roughness Rₐ selected from about 0.05 μm to about 2 μm. In some embodiments, the magnesium alloy foil has a root-mean-square roughness R_{q} selected from about 0.05 μm to about 3 μm. In some embodiments, the magnesium alloy foil has a surface roughness R_{z} selected from about 0.25 μm to about 3 μm.

In some embodiments, the magnesium alloy foil contains from 50 atomic percent magnesium to 99.8 atomic percent magnesium.

In some embodiments, the magnesium alloy foil further comprises aluminum, copper, lithium, manganese, zinc, calcium, zirconium, silver, yttrium, cerium, lanthanum, or a combination thereof.

In some embodiments, the magnesium alloy foil further comprises at least two of aluminum, copper, lithium, manganese, zinc, calcium, zirconium, silver, yttrium, cerium, and lanthanum.

In some embodiments, the magnesium alloy foil further comprises from about 0.25 to about 15 weight percent aluminum.

In some embodiments, the magnesium alloy foil further comprises from about 0.25 to about 10 weight percent zinc.

In some embodiments, the magnesium alloy foil further comprises from about 0.01 to about 5 weight percent manganese.

In some embodiments, the magnesium alloy foil further comprises from about 0.25 to about 10 weight percent calcium.

In some embodiments, the magnesium alloy foil further comprises from about 1 to about 20 weight percent lithium.

In some embodiments, the magnesium alloy foil further comprises from about 0.05 to about 10 weight percent copper.

In preferred embodiments, the positive-electrode current collector is substantially copper-free. In these embodiments, the lithium-ion battery may be substantially copper-free.

In some embodiments, the magnesium alloy foil contains a magnesium alloy selected from the group consisting of AJ52A, AJ62A, AM50A, AM60A, AM60B, AM100A, AMX602, AS41A, AZ31B, AZ31C, AZ31D, AZ61A, AZ63A, AZ63B, AZ63C, AZ63D, AZ80A, AZ81A, AZ91A, AZ91B, AZ91C, AZ91D, AZ91E, AZ92A, AZ101A, AZX111, AZX211, AZX311, K1A, LA21, LA41, LA61, LA91, LA141, LZ21, LZ41, LZ61, LZ91, LZ141, LAZ941, M1A, ZC63A, ZE41A, ZEK100, ZK40A, ZK51A, ZK60A, ZK61A, and combination thereof.

In certain embodiments, the magnesium alloy foil compositionally consists essentially of AJ52A, AJ62A, AM50A, AM60A, AM60B, AM100A, AMX602, AS41A, AZ31B, AZ31C, AZ31D, AZ61A, AZ63A, AZ63B, AZ63C, AZ63D, AZ80A, AZ81A, AZ91A, AZ91B, AZ91C, AZ91D, AZ91E, AZ92A, AZ101A, AZX111, AZX211, AZX311, K1A, LA21, LA41, LA61, LA91, LA141, LZ21, LZ41, LZ61, LZ91, LZ141, LAZ941, M1A, ZC63A, ZE41A, ZEK100, ZK40A, ZK51A, ZK60A, ZK61A, and combination thereof.

In some embodiments, the magnesium alloy foil is a rolled foil.

In some embodiments, the magnesium alloy foil has a bulk electrical resistivity from about 5 to about 25 μΩ-cm.

In some embodiments, the magnesium alloy foil has an ultimate tensile strength greater than 150 MPa. The magnesium alloy foil may have an elongation to fracture greater than 0.5%, for example.

In some embodiments, the lithium-ion battery comprises an electrode/separator stack containing the negative electrode, the separator, and the positive electrode. The electrode/separator stack may be wound, folded, or flat.

In some embodiments, the positive-electrode current collector is joined to a conductive metal body (e.g., tab) via ultrasonic welding, laser welding, an adhesive, or a combination thereof. In certain embodiments, the positive-electrode current collector is mechanically joined to a conductive metal body.

In some embodiments, the positive-electrode current collector is joined to a body material comprising an additional magnesium alloy (different than the magnesium alloy in the positive-electrode current collector).

In some embodiments, the additional magnesium alloy is compositionally the same as the magnesium alloy foil in the positive-electrode current collector.

In some embodiments, the positive-electrode current collector is joined to a tabbing material comprising aluminum, an aluminum alloy, iron, steel, stainless steel, nickel, copper, zinc, a zinc alloy, or a combination thereof.

In some embodiments, magnesium alloys are used in both current collectors, at both the anode and cathode sides. In some embodiments, the negative-electrode current collector comprises a second magnesium alloy foil that contains at least 50 atomic percent magnesium. The second magnesium alloy foil in the negative-electrode current collector may be compositionally the same as the magnesium alloy foil in the positive-electrode current collector.

In some embodiments, the negative-electrode current collector comprises a copper or copper alloy foil.

Some embodiments provide a sealed lithium-ion battery comprising the lithium-ion battery as disclosed, with a magnesium alloy utilized at the cathode, wherein the sealed lithium-ion battery further comprises a battery casing that sealably encloses the lithium-ion battery from the environment. In some embodiments, the battery casing has a cylindrical form factor. In some embodiments, the battery casing has a rigid rectangular form factor. In some embodiments, the battery casing has a prismatic form factor. In some embodiments, the battery casing has a soft-pouch form factor.

In some embodiments, positive electrode material is mixed in a solvent and deposited onto the magnesium alloy foil. In some embodiments, positive electrode material is mixed in an alkaline aqueous solution and deposited onto the magnesium alloy foil. In some embodiments, positive electrode material is deposited via a dry process. The electrolyte may be a liquid, a solid, a semi-solid, or a gel.

In some embodiments, the electrolyte comprises a fluorine-containing compound. The electrolyte may contain from about 10 mM to about 6 M of the fluorine-containing compound, for example.

In some embodiments, the electrolyte comprises a material selected from the group consisting of lithium bis(trifluoromethansulfonyl)imide, lithium hexafluorophosphate, lithium bis(fluorosulfonyl)imide, lithium trifluoromethane sulfonate, lithium perchlorate, and combinations thereof.

In some embodiments, the electrolyte comprises ethylene carbonate, propylene carbonate, dimethyl carbonate, diethyl carbonate, ethyl methyl carbonate, fluoroethylene carbonate, 1,2-dimethoxyethane, 1,3-dioxolane, acetonitrile, ethyl acetate, tetrahydrofuran, polyethylene oxide, or a combination thereof.

In some embodiments, the electrolyte comprises fluoroethylene carbonate, vinylene carbonate, methylene ethylene carbonate, propane sultone, biphenyl, lithium bis(oxalato)borate, lithium difluoro(oxalato)borate, lithium bis(fluorosulfonyl)imide, or a combination thereof.

Certain variations provide a lithium-ion battery comprising:
(a) a negative electrode;
(b) a negative-electrode current collector in contact with the negative electrode;
(c) a lithium-containing electrolyte;
(d) a separator interposed between the negative electrode and the positive electrode, wherein the separator is permeable to lithium ions;
(e) a positive electrode; and
(f) a positive-electrode current collector in contact with the positive electrode,
wherein the positive-electrode current collector comprises a foil consisting essentially of magnesium.

Other variations provide a lithium-ion-battery current collector for use in transferring electrical current to or from a positive electrode in a lithium-ion-battery, wherein the lithium-ion-battery current collector consists essentially of a magnesium alloy foil containing at least 50 atomic percent magnesium, wherein the lithium-ion-battery current collector is copper-free, and wherein the magnesium alloy foil is characterized by:
(a) a thickness selected from about 4 μm to about 50 μm;
(b) an average roughness Rₐ selected from about 0.05 μm to about 2 μm;
(c) a root-mean-square roughness R_{q} selected from about 0.05 μm to about 3 μm;
(d) a surface roughness R_{z} selected from about 0.25 μm to about 3 μm;
(e) a bulk electrical resistivity no greater than 25 μΩ-cm;
(f) an ultimate tensile strength greater than 150 MPa; and
(g) an elongation to fracture greater than 0.5%.

Other variations provide methods of making a lithium-ion battery. In some embodiments, a method of making a lithium-ion battery comprises:
(a) providing a negative electrode;
(b) contacting a negative-electrode current collector with the negative electrode;
(c) providing a positive electrode;
(d) contacting a positive-electrode current collector with the positive electrode;
(e) providing a lithium-containing electrolyte; and
(f) interposing a separator between the negative electrode and the positive electrode, wherein the separator is permeable to lithium ions,
wherein the negative-electrode current collector comprises a magnesium alloy foil containing at least 50 atomic percent magnesium.

In some methods, the method further comprises sealing the battery in a battery casing to create a sealed lithium-ion battery that is isolated from the environment. Preferably, the method is conducted such that the sealed lithium-ion battery contains less than 500 parts per million water by mass. Preferably, the method is conducted such that the sealed lithium-ion battery contains less than 500 parts per million oxygen by volume. Preferably, the method is conducted such that the sealed lithium-ion battery contains less than 1000 parts per million hydrofluoric acid by mass.

In other embodiments, a method of making a lithium-ion battery comprises:
(a) providing a negative electrode;
(b) contacting a negative-electrode current collector with the negative electrode;
(c) providing a positive electrode;
(d) contacting a positive-electrode current collector with the positive electrode;
(e) providing a lithium-containing electrolyte; and
(f) interposing a separator between the negative electrode and the positive electrode, wherein the separator is permeable to lithium ions,
wherein the positive-electrode current collector comprises a magnesium alloy foil containing at least 50 atomic percent magnesium.

In some methods using a magnesium alloy in the positive-electrode current collector, the method further comprises sealing the battery in a battery casing to create a sealed lithium-ion battery that is isolated from the environment. Preferably, the method is conducted such that the sealed lithium-ion battery contains less than 500 parts per million water by mass. Preferably, the method is conducted such that the sealed lithium-ion battery contains less than 500 parts per million oxygen by volume. Preferably, the method is conducted such that the sealed lithium-ion battery contains less than 1000 parts per million hydrofluoric acid by mass.

### BRIEF DESCRIPTION OF THE FIGURES

The foregoing aspects and others will be readily appreciated by the skilled artisan from the following description of illustrative embodiments when read in conjunction with the accompanying drawings. The drawings are illustrative only and are not intended to be exhaustive or to limit the disclosure herein.

FIG. 1A is a table of aluminum- and zinc-containing magnesium alloys that may be used in embodiments of the invention.

FIG. 1B is a table of aluminum- and calcium-containing magnesium alloys that may be used in embodiments of the invention.

FIG. 1C is a table of aluminum-containing magnesium alloys that may be used in embodiments of the invention.

FIG. 1D is a table of lithium-containing magnesium alloys that may be used in embodiments of the invention.

FIG. 1E is a table of zinc-containing magnesium alloys that may be used in embodiments of the invention.

FIG. 1F is a table of rare-earth-containing magnesium alloys that may be used in embodiments of the invention.

FIG. 1G is a table of dual-component magnesium alloys that may be used in embodiments of the invention.

FIG. 2 shows an exemplary electrode/separator stack configured within a single-layer full pouch cell, in some variations.

FIG. 3 depicts an exemplary cell configuration that may be used in some variations.

FIG. 4 a graph of the gravimetric capacity (mAh/g) as a function of atomic percent of magnesium, with the balance being aluminum, and a fixed alloy thickness (1 μm), using chronoamperometry in Example 3.

FIG. 5 shows voltammograms of copper (dash-dot line), aluminum (solid line), and magnesium alloy AZ31B (dotted line) foils measured via cyclic voltammetry in Example 4.

FIG. 6 is a plot of current density versus time for copper (dash-dot line), aluminum (solid line), and magnesium alloy AZ31B (dotted line) foils measured via chronoamperometry over the course of a 12-hour hold at 20 mV vs Li⁰/Li⁺, in Example 5.

FIG. 7 shows a photographic image of a copper foil before (image A) and after (image B) a 12-hour chronoamperometry hold at 20 mV vs Li⁰/Li⁺, in Example 6.

FIG. 8 shows a photographic image of ab aluminum foil before (image A) and after (image B) a 12-hour chronoamperometry hold at 20 mV vs Li⁰/Li⁺, in Example 6.

FIG. 9 shows a photographic image of a AZ31B magnesium alloy foil before (image A) and after (image B) a 12-hr chronoamperometry hold at 20 mV vs Li⁰/Li⁺, in Example 6.

FIG. 10 shows stress-strain curves of a 10-μm-thick copper foil (dash-dot-dot line), 15-μm-thick aluminum foil (dashed line), a 35-μm-thick magnesium alloy AZ31B foil (dotted line), a 35-μm-thick magnesium alloy AZ31B foil after a 1-hour anneal at 180° C. (dash-dot line), and a 35-μm-thick magnesium alloy LZ141 foil (solid line) in Example 8.

FIG. 11 shows photographic images of graphite slurries comprising PVDF binder in NMP (image A), CMC-SBR binder in a pH 7 aqueous solution (image B), and CMC-SBR binder in a pH 12 aqueous solution (image C) cast on magnesium alloy AZ31B foil and subsequently dried, in Example 9.

FIG. 12 is a XRD diffractogram of magnesium alloy AZ31B foil, in Example 10.

FIG. 13 is an EDX spectrum of magnesium alloy AZ31B foil, in Example 10.

FIG. 14 is a graph of normalized capacity versus cycle life for single-layer pouch cells assembled using 10 μm copper (dashed line), 12 μm aluminum (solid line), or 35 μm magnesium alloy AZ31B (dotted line) foils as current collectors, in Example 11.

FIG. 15 is a graph of normalized capacity versus cycle life for lithium-ion coin cells using copper (upward triangles), AZX211 (diamonds), LZ141 (circles), AZ31B (left triangles), ZK60A (stars), and magnesium (×) current-collector foils, in Examples 12 and 13.

FIG. 16 shows the results of cyclic-voltammetry experiments for Example 14, demonstrating that magnesium alloy foils can serve as positive-electrode current collectors in lithium-ion systems, with good oxidative stability similar to aluminum up to 4.5 V vs. Li⁰/Li⁺ as shown by the stable current density between 3.5 and 4.5 V vs. Li⁰/Li⁺.

### DETAILED DESCRIPTION OF EMBODIMENTS

The principles, compositions, systems, and methods of the present disclosure will be described in detail by reference to various non-limiting embodiments of the technology.

This description will enable one skilled in the art to make and use the technology, and it describes several embodiments, adaptations, variations, alternatives, and uses of the technology. These and other embodiments, features, and advantages of the present technology will become more apparent to those skilled in the art when taken with reference to the following detailed description in conjunction with the accompanying drawings.

Unless defined otherwise, all technical and scientific terms used herein have the same meaning as is commonly understood by one of ordinary skill in the art to which this technology belongs.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phrase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phrase “consisting essentially of” limits the scope of a claim to the specified elements or method steps, plus those that do not materially affect the basis and novel characteristic(s) of the claimed subject matter.

With respect to the terms “comprising” (synonymously, “including”), “consisting of,” and “consisting essentially of,” where one of these three terms is used herein, the presently disclosed and claimed subject matter may include the use of either of the other two terms, except when used in Markush groups. Thus in some embodiments not otherwise explicitly recited, any instance of “comprising” may be replaced by “consisting of” or, alternatively, by “consisting essentially of” The term “including” should be read as meaning “including, without limitation” or the like; the term “example” is used to provide exemplary instances of the item in discussion, not an exhaustive or limiting list thereof.

Adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this patent application refers to technologies that would be apparent or known to one of ordinary skill in the art, such technologies encompass those apparent or known to the skilled artisan now or at any time in the future.

In this specification, hypotheses and theories are disclosed, it being understood that the present invention is not limited to the proposed hypotheses and theories.

In this specification, with respect to a concentration of a component within a composition, a percentage is in reference to weight percent (referred to as wt. % or wt %), unless indicated otherwise.

As used in this specification and the appended claims, the singular forms “a,” “an,” and “the” include plural referents unless the context clearly indicates otherwise. The terms “a” or “an” should be read as meaning “at least one,” “one or more” or the like. The presence of broadening words and phrases such as “one or more,” “at least,” “but not limited to” or other like phrases in some instances shall not be read to mean that the narrower case is intended or required in instances where such broadening phrases may be absent.

As used herein, the term “portion” may be understood to mean an entire component or any sub-range or fraction thereof. For example, a portion of a substrate front surface may be understood to mean the entire substrate front surface, one-half of the substrate front surface, one-third of the substrate front surface, one-fourth of the substrate front surface, or any other area fraction of the substrate front surface. As another example, a portion of a surface may be understood to mean an entire surface or any sub-range or fraction thereof. For example, a portion of surface may be understood to mean the entire surface, up to 10 nm below a surface, up to 20 nm below a surface, up to 30 nm below a surface, up to 40 nm below a surface, up to 50 nm below a surface, up to 60 nm below a surface, up to 70 nm below a surface, up to 80 nm below a surface, up to 90 nm below a surface, or up to 100 nm below a surface. As another example, if it is stated that a component is “on at least a portion” of a substrate rear surface, then—unless specifically stated otherwise or infeasible—the component may be on the entire substrate rear surface or may be on a fraction of the total area of the substrate rear surface.

The disclosure herein relates to a lithium-ion battery that comprises a magnesium alloy foil current collector. The disclosed magnesium alloy foil current collectors preferably do not react appreciably with lithium present in the lithium-ion battery and preferably do not contribute to electrochemical reactions in the battery in the typical operating window of the battery. The disclosed lithium-ion batteries can reduce lithium-ion battery production costs and weight while maintaining desirable mechanical, electrical, and electrochemical performance.

Disclosed herein are rollable, magnesium alloy foils that can replace copper foil as the negative-electrode current collector in lithium-ion batteries. It is highly desirable to use magnesium, which is five times less dense (1.738 g/cm³) than copper (8.96 g/cm³) at room temperature. The spot price of magnesium is generally $2-3/kg versus $10-12/kg for copper. When accounting for both the density difference and the cost difference, a given volume of copper costs over 20× more than the same volume of magnesium.

Disclosed herein is a magnesium alloy of AZ31B that has similar chronoamperometry-derived absolute areal capacity (4.6 μAh/cm²) compared to battery-grade copper (5.7 μAh/cm²) at room temperature (about 25° C.).

Disclosed herein is the finding that the base metal aluminum is unsuitable for use as a negative-electrode current collector due to its lithium reactivity and high capacity (>760 μAh/cm²).

Disclosed herein are combinatorially sputtered alloys of aluminum and magnesium of identical thickness and their measured gravimetric capacity (mAh/g) to determine minimum required magnesium content to shut down lithiation at low potentials versus Li⁰/Li⁺.

Some variations of the invention provide a lithium-ion battery comprising:
(a) a negative electrode (anode);
(b) a negative-electrode current collector in contact with the negative electrode;
(c) a lithium-containing electrolyte;
(d) a separator interposed between the negative electrode and the positive electrode, wherein the separator is permeable to lithium ions;
(e) a positive electrode (cathode); and
(f) a positive-electrode current collector in contact with the positive electrode,
wherein the negative-electrode current collector comprises a magnesium alloy foil containing at least 50 atomic percent magnesium.

In some embodiments, the negative-electrode current collector consists essentially of the magnesium alloy foil.

In some embodiments, the magnesium alloy foil has a thickness selected from about 4 μm to about 50 μm. In various embodiments, the magnesium alloy foil has a thickness of about, at least about, or at most about 4 μm, 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, 20 μm, 21 μm, 22 μm, 23 μm, 24 μm, 25 μm, 26 μm, 27 μm, 28 μm, 29 μm, 30 μm, 31 μm, 32 μm, 33 μm, 34 μm, 35 μm, 36 μm, 37 μm, 38 μm, 39 μm, 40 μm, 41 μm, 42 μm, 43 μm, 44 μm, 45 μm, 46 μm, 47 μm, 48 μm, 49 μm, or 50 μm, including any intervening range (e.g., about 7-33 μm).

In some embodiments, the magnesium alloy foil has an average roughness Rₐ selected from about 0.05 μm to about 2 μm. In some embodiments, the magnesium alloy foil has a root-mean-square roughness R_{q} selected from about 0.05 μm to about 3 μm. In some embodiments, the magnesium alloy foil has a surface roughness R_{z} selected from about 0.25 μm to about 3 μm.

In some embodiments, the magnesium alloy foil contains from 50 atomic percent magnesium to 99.8 atomic percent magnesium. In various embodiments, the magnesium alloy foil contains about, at least about, or at most about 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 99.5, or 99.8 at % Mg, including any intervening range (e.g., about 75-95 at % Mg).

In some embodiments, the magnesium alloy foil further comprises aluminum, copper, lithium, manganese, zinc, calcium, zirconium, silver, yttrium, cerium, lanthanum, or a combination thereof. In certain embodiments, the magnesium alloy foil further comprises at least two of aluminum, copper, lithium, manganese, zinc, calcium, zirconium, silver, yttrium, cerium, and lanthanum.

In some embodiments, the magnesium alloy foil further comprises from about 0.25 to about 15 weight percent aluminum.

In some embodiments, the magnesium alloy foil further comprises from about 0.25 to about 10 weight percent zinc.

In some embodiments, the magnesium alloy foil further comprises from about 0.01 to about 5 weight percent manganese.

In some embodiments, the magnesium alloy foil further comprises from about 0.25 to about 10 weight percent calcium.

In some embodiments, the magnesium alloy foil further comprises from about 1 to about 20 weight percent lithium.

In some embodiments, the magnesium alloy foil further comprises from about 0.05 to about 10 weight percent copper.

In preferred embodiments, the negative-electrode current collector is substantially copper-free. In these embodiments, the lithium-ion battery may be substantially copper-free. In this specification, “substantially copper-free” means less than 0.10 wt % copper, and refers to copper in elemental form (Cu) as well as copper in any compounds (e.g., CuO, Cu₂O, or CuF₂).

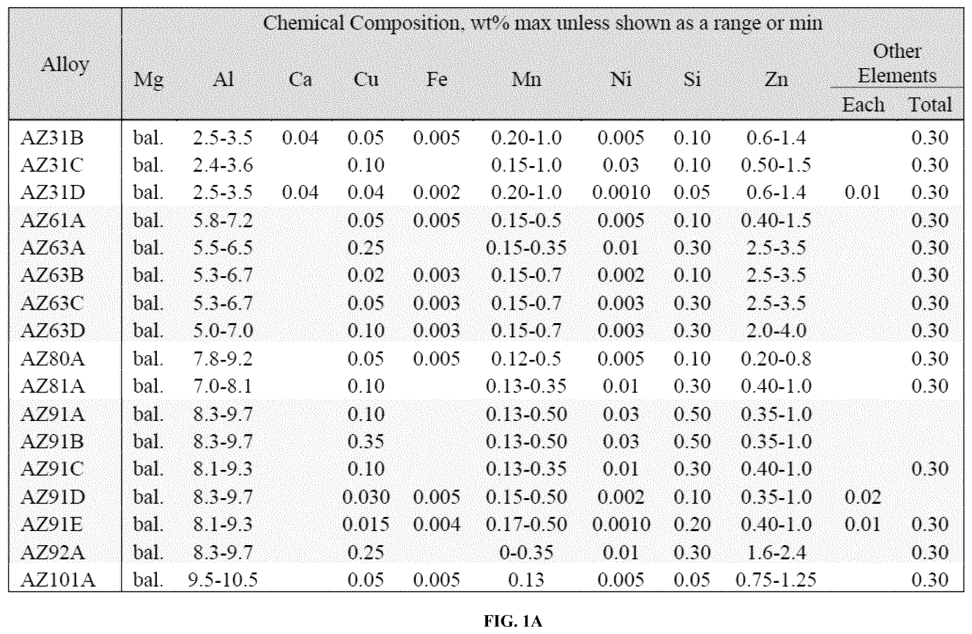

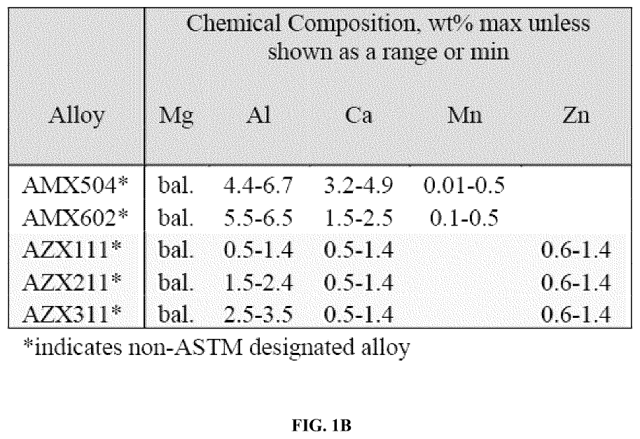

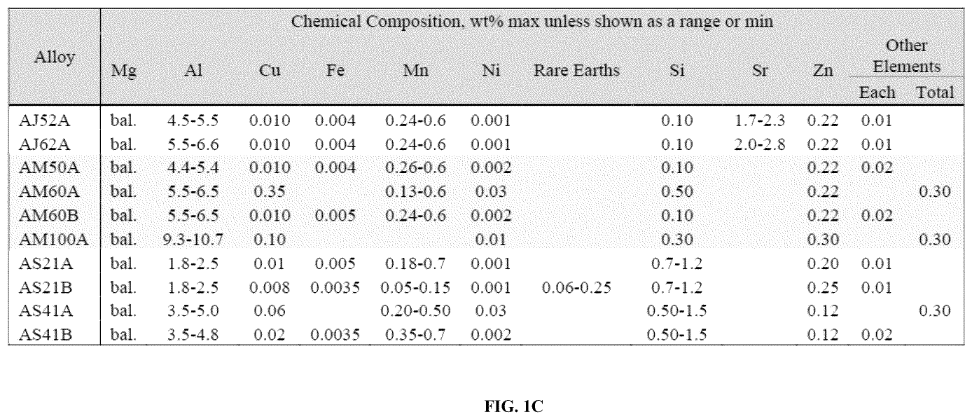

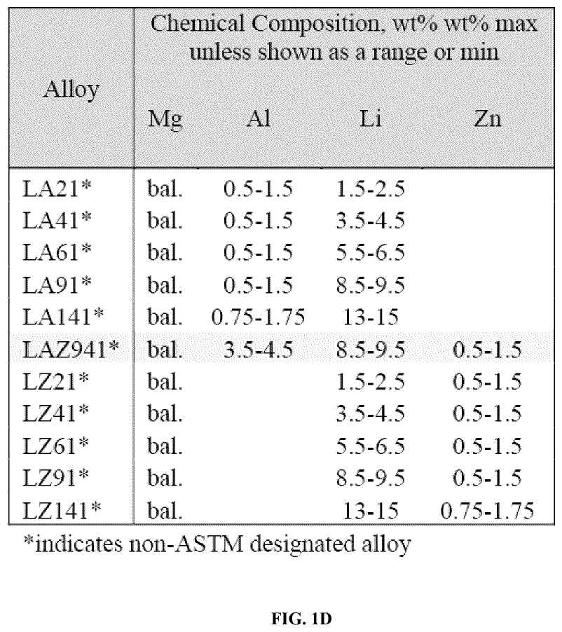

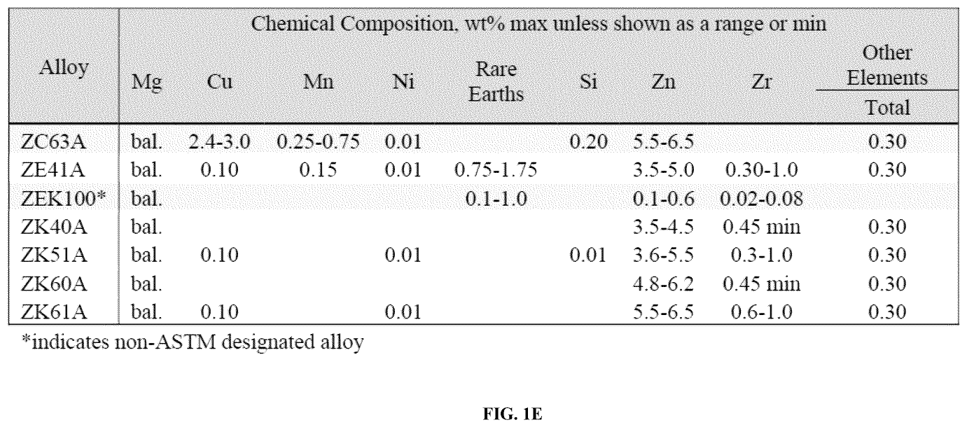

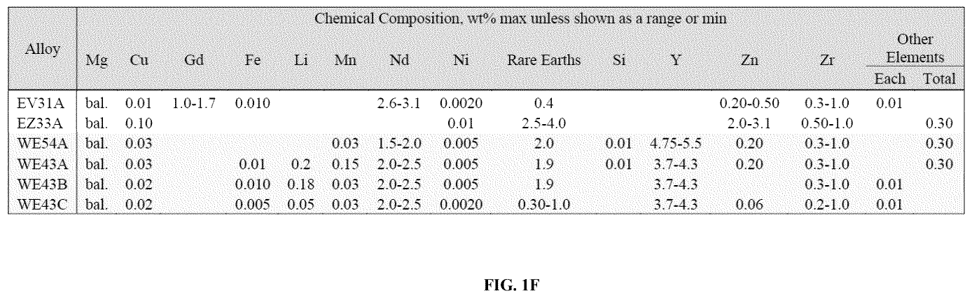

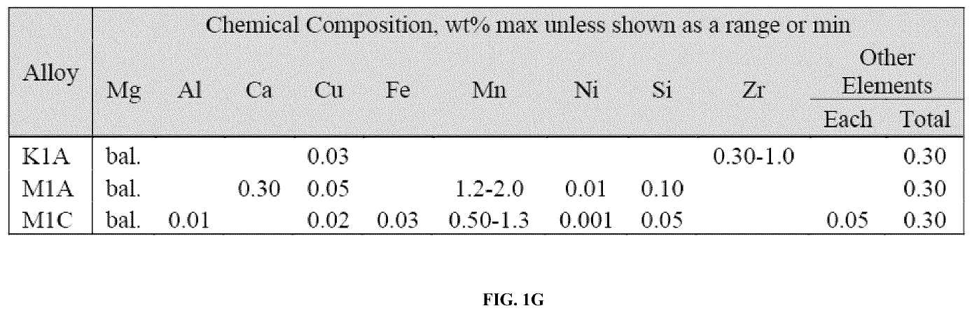

FIGS. 1A to 1G present tables of magnesium alloys that may be used in various embodiments of the invention. In all tables, “bal.” indicates that the balance of the alloy composition is Mg, and * indicates a non-ASTM designated Mg alloy. FIG. 1A is a table of aluminum- and zinc-containing magnesium alloys that may be used in embodiments of the invention. FIG. 1B is a table of aluminum- and calcium-containing magnesium alloys that may be used in embodiments of the invention. FIG. 1C is a table of aluminum-containing magnesium alloys that may be used in embodiments of the invention. FIG. 1D is a table of lithium-containing magnesium alloys that may be used in embodiments of the invention. FIG. 1E is a table of zinc-containing magnesium alloys that may be used in embodiments of the invention. FIG. 1F is a table of rare-earth-containing magnesium alloys that may be used in embodiments of the invention. FIG. 1G is a table of dual-component magnesium alloys that may be used in embodiments of the invention.

In some embodiments, the magnesium alloy foil contains a magnesium alloy selected from the group consisting of AJ52A, AJ62A, AM50A, AM60A, AM60B, AM100A, AMX602, AS41A, AZ31B, AZ31C, AZ31D, AZ61A, AZ63A, AZ63B, AZ63C, AZ63D, AZ80A, AZ81A, AZ91A, AZ91B, AZ91C, AZ91D, AZ91E, AZ92A, AZ101A, AZX111, AZX211, AZX311, K1A, LA21, LA41, LA61, LA91, LA141, LZ21, LZ41, LZ61, LZ91, LZ141, LAZ941, M1A, ZC63A, ZE41A, ZEK100, ZK40A, ZK51A, ZK60A, ZK61A, and combination thereof.

In certain embodiments, the magnesium alloy foil compositionally consists essentially of AJ52A, AJ62A, AM50A, AM60A, AM60B, AM100A, AMX602, AS41A, AZ31B, AZ31C, AZ31D, AZ61A, AZ63A, AZ63B, AZ63C, AZ63D, AZ80A, AZ81A, AZ91A, AZ91B, AZ91C, AZ91D, AZ91E, AZ92A, AZ101A, AZX111, AZX211, AZX311, K1A, LA21, LA41, LA61, LA91, LA141, LZ21, LZ41, LZ61, LZ91, LZ141, LAZ941, M1A, ZC63A, ZE41A, ZEK100, ZK40A, ZK51A, ZK60A, ZK61A, and combination thereof.

In some embodiments, the magnesium alloy foil is a rolled foil.

In some embodiments, the magnesium alloy foil has an areal capacity from about 2 to about 250 μAh/cm² at a foil thickness of about 4 μm to about 50 μm or less when biased at 20 mV vs Li⁰/Li⁺ for 12 hours.

In some embodiments, the magnesium alloy foil has a bulk electrical resistivity from about 5 to about 25 μΩ-cm. In exemplary embodiments, the magnesium alloy foil has a bulk electrical resistivity ranging from 5 μΩ-cm to 25 μΩ-cm, from 5 μΩ-cm to 20 μΩ-cm, from 5 μΩ-cm to 15 μΩ-cm, from 5 μΩ-cm to 12.5 μΩ-cm, from 5.5 μΩ-cm to 10 μΩ-cm, or from 6 μΩ-cm to 9.5 μΩ-cm.

In some embodiments, the magnesium alloy foil has an ultimate tensile strength greater than 150 MPa. In exemplary embodiments, the magnesium alloy foil has an ultimate tensile strength ranging from 150 MPa to 400 MPa, from 150 MPa to 300 MPa, from 200 MPa to 400 MPa, or from 200 MPa to 300 MPa.

The magnesium alloy foil may have an elongation to fracture greater than 0.5%. In exemplary embodiments, the magnesium alloy foil has an elongation to fracture greater than 0.5%, greater than 1%, greater than 2%, greater than 3%, or ranging from 0.5% to 5%, from 1% to 5%, from 2% to 5%, from 2% to 10%, from 2% to 15%, from 3% to 15%, from 3% to 20%, or from 5% to 50%.

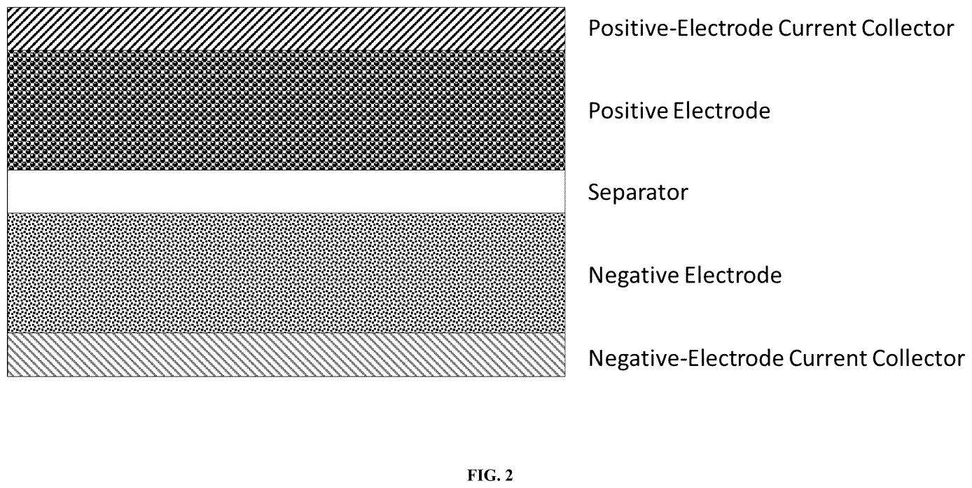

The lithium-ion battery may comprise an electrode/separator stack containing the negative electrode, the separator, and the positive electrode. FIG. 2 shows an exemplary electrode/separator stack configured within a single-layer full pouch cell. The single-layer full pouch cell comprises, from the bottom up, a negative-electrode current collector, a negative electrode (anode), a separator, a positive electrode, and a positive-electrode current collector. An exemplary thickness of the negative-electrode current collector is about 4 microns to about 50 microns. An exemplary thickness of the negative electrode (e.g., graphite) is about 50 to about 70 microns. An exemplary thickness of the separator is about 25 microns. An exemplary thickness of the positive electrode (e.g., lithium iron phosphate, LiFePO₄) is about 70 microns. An exemplary thickness of the positive-electrode current collector is about 6 microns to about 50 microns.

In some embodiments, the electrode/separator stack is wound. In some embodiments, the electrode/separator stack is folded. In some embodiments, the electrode/separator stack is flat.

In some embodiments, the negative-electrode current collector is joined to a conductive metal body via ultrasonic welding, laser welding, an adhesive, or a combination thereof. In some embodiments, the negative-electrode current collector is mechanically joined to a conductive metal body.

In some embodiments, the negative-electrode current collector is joined to a body material comprising an additional magnesium alloy (i.e., different than the magnesium alloy in the negative-electrode current collector). The additional magnesium alloy may be compositionally the same as the magnesium alloy foil in the negative-electrode current collector, or different.

In some embodiments, the negative-electrode current collector is joined to a body material comprising aluminum, an aluminum alloy, iron, steel, stainless steel, nickel, copper, zinc, a zinc alloy, or a combination thereof.

When using a magnesium alloy foil as a current collector, preferred tab and terminal materials may include magnesium alloys of the same or different composition as the current collector; aluminum or aluminum alloys; steel; stainless steel; zinc; or a composite thereof, for example. In some embodiments, a current collector (e.g., magnesium alloy foil) is joined to a tabbing material comprising magnesium alloys of the same or different composition as the current collector; aluminum or aluminum alloys; steel; stainless steel; zinc; or a composite thereof, for example.

The positive-electrode current collector is typically made of aluminum foil and tabbed to aluminum tabs. In some embodiments, the positive-electrode current collector comprises aluminum or aluminum alloy foil. As discussed elsewhere, magnesium alloy foils may also be used as the positive-electrode current collector. In some embodiments, the positive-electrode current collector comprises a magnesium alloy foil, and the magnesium alloy foil of the positive-electrode and negative-electrode current collectors are compositionally the same.

In some embodiments, the negative-electrode current collector (e.g., magnesium alloy foil) has an integrated tab with a portion of the current collector remaining uncoated and directly extending outside of the battery enclosure. In some embodiments, the negative-electrode current collector (e.g., magnesium alloy foil) is directly joined to the battery casing that serves as a terminal.

In some embodiments, the positive-electrode current collector comprises a second magnesium alloy foil, wherein the second magnesium alloy foil contains at least 50 atomic percent magnesium. In certain embodiments, the second magnesium alloy foil is compositionally the same as the magnesium alloy foil in the negative-electrode current collector.

Some embodiments provide a sealed lithium-ion battery comprising the lithium-ion battery as disclosed, wherein the sealed lithium-ion battery further comprises a battery casing that sealably encloses the lithium-ion battery from the environment. In some embodiments, the battery casing has a cylindrical form factor. In some embodiments, the battery casing has a rigid rectangular form factor. In some embodiments, the battery casing has a prismatic form factor. In some embodiments, the battery casing has a soft-pouch form factor. The material of the battery casing may vary, such as stainless steel, aluminum alloys, nickel-plated steel, or aluminum-polymer composites, for example. The material of the battery casing is typically selected to balance strength, weight, and safety of the sealed battery.

When using a magnesium alloy foil as a current collector joined to a more-noble metal body such as nickel or copper, the sealed battery including electrolyte preferably contains <500 ppm (by mass) water, <500 ppm (by volume) oxygen, and/or <1,000 ppm (by mass) hydrofluoric acid. In various embodiments, the sealed battery including electrolyte contains less than about 1000 ppm, 900 ppm, 800 ppm, 700 ppm, 600 ppm, 500 ppm, 400 ppm, 300 ppm, 200 ppm, 100 ppm, 50 ppm, or 10 ppm water by mass. In various embodiments, the sealed battery including electrolyte contains less than about 1000 ppm, 900 ppm, 800 ppm, 700 ppm, 600 ppm, 500 ppm, 400 ppm, 300 ppm, 200 ppm, 100 ppm, 50 ppm, or 10 ppm oxygen by volume. In various embodiments, the sealed battery including electrolyte contains less than about 2000 ppm, 1500 ppm, 1000 ppm, 500 ppm, 200 ppm, 100 ppm, or 50 ppm hydrofluoric acid by mass. In this specification, the weight or volume basis for calculating water, oxygen, or hydrofluoric acid concentrations in the sealed battery includes all internal components of the battery, electrode stack, and electrolyte, but does not include the outer battery case, box, or other containment means.

In some embodiments of the lithium-ion battery, the negative electrode comprises graphite. In some embodiments, the negative electrode comprises graphite and silicon. In some embodiments, the negative electrode comprises a majority of silicon on a weight basis. In some embodiments, the negative electrode comprises lithium titanate. In some embodiments, the negative electrode comprises metallic lithium.

In some embodiments, the negative electrode further comprises an organic binder. The organic binder may be selected from the group consisting of carboxymethyl cellulose, styrene-butadiene rubber, polyacrylic acid, polyvinyl alcohol, polyethylene oxide, polyvinylidene fluoride, polytetrafluoroethylene, and mixtures thereof.

In some embodiments, the negative electrode further comprises a conductive additive selected from the group consisting of carbon black, single-walled carbon nanotubes, multi-walled carbon nanotubes, graphene, acetylene black, and mixtures thereof.

In certain embodiments, the negative electrode comprises from 0 to about 10 weight percent of the combined total of carbon black and polyvinylidene fluoride.

In certain embodiments, the negative electrode comprises from 0 to about 10 weight percent of the combined total of carboxymethyl cellulose and styrene butadiene rubber.

In some embodiments, the negative electrode material is mixed in a solvent and deposited onto the magnesium alloy foil. In some embodiments, the negative electrode material is mixed in an alkaline aqueous solution and deposited onto the magnesium alloy foil. In some embodiments, the negative electrode material is deposited via a dry process. The electrolyte may be a liquid, a solid, a semi-solid, a gel, or a combination thereof.

In some embodiments of the lithium-ion battery, the electrolyte comprises a fluorine-containing compound. The electrolyte may contain from about 10 mM to about 6 M of the fluorine-containing compound, for example.

In some embodiments, the electrolyte comprises a material selected from the group consisting of lithium bis(trifluoromethansulfonyl)imide, lithium hexafluorophosphate, lithium bis(fluorosulfonyl)imide, lithium trifluoromethane sulfonate, lithium perchlorate, and combinations thereof.

In some embodiments, the electrolyte comprises ethylene carbonate, propylene carbonate, dimethyl carbonate, diethyl carbonate, ethyl methyl carbonate, fluoroethylene carbonate, 1,2-dimethoxyethane, 1,3-dioxolane, acetonitrile, ethyl acetate, tetrahydrofuran, polyethylene oxide, or a combination thereof.

In some embodiments, the electrolyte comprises fluoroethylene carbonate, vinylene carbonate, methylene ethylene carbonate, propane sultone, biphenyl, lithium bis(oxalato)borate, lithium difluoro(oxalato)borate, lithium bis(fluorosulfonyl)imide, or a combination thereof.

LiPF₆ is commonly used when aluminum is the positive-electrode current collector to passivate the aluminum and increase the operating voltage window. In an exemplary embodiment, the electrolyte comprises a fluorine-containing compound, and the top 10, 50, or 100 nanometers of the magnesium alloy foil comprises fluorinated species.

Some variations provide a lithium-ion battery in which a magnesium alloy is utilized at the positive electrode (cathode), wherein the lithium-ion battery comprises:
(a) a negative electrode;
(b) a negative-electrode current collector in contact with the negative electrode;
(c) a lithium-containing electrolyte;
(d) a separator interposed between the negative electrode and the positive electrode, wherein the separator is permeable to lithium ions;
(e) a positive electrode; and
(f) a positive-electrode current collector in contact with the positive electrode,
wherein the positive-electrode current collector comprises a magnesium alloy foil containing at least 50 atomic percent magnesium.

In some embodiments, the positive-electrode current collector consists essentially of the magnesium alloy foil.

In some embodiments, the magnesium alloy foil has a thickness selected from about 4 μm to about 50 μm. In some embodiments, the magnesium alloy foil has an average roughness Rₐ selected from about 0.05 μm to about 2 μm. In some embodiments, the magnesium alloy foil has a root-mean-square roughness R_{q} selected from about 0.05 μm to about 3 μm. In some embodiments, the magnesium alloy foil has a surface roughness R_{z} selected from about 0.25 μm to about 3 μm.

In some embodiments, the magnesium alloy foil contains from 50 atomic percent magnesium to 99.8 atomic percent magnesium.

In some embodiments, the magnesium alloy foil further comprises aluminum, copper, lithium, manganese, zinc, calcium, zirconium, silver, yttrium, cerium, lanthanum, or a combination thereof.

In some embodiments, the magnesium alloy foil further comprises at least two of aluminum, copper, lithium, manganese, zinc, calcium, zirconium, silver, yttrium, cerium, and lanthanum.

In some embodiments, the magnesium alloy foil further comprises from about 0.25 to about 15 weight percent aluminum.

In some embodiments, the magnesium alloy foil further comprises from about 0.25 to about 10 weight percent zinc.

In some embodiments, the magnesium alloy foil further comprises from about 0.01 to about 5 weight percent manganese.

In some embodiments, the magnesium alloy foil further comprises from about 0.25 to about 10 weight percent calcium.

In some embodiments, the magnesium alloy foil further comprises from about 1 to about 20 weight percent lithium.

In some embodiments, the magnesium alloy foil further comprises from about 0.05 to about 10 weight percent copper.

In preferred embodiments, the positive-electrode current collector is substantially copper-free. In these embodiments, the lithium-ion battery may be substantially copper-free.

In some embodiments, the magnesium alloy foil contains a magnesium alloy selected from the group consisting of AJ52A, AJ62A, AM50A, AM60A, AM60B, AM100A, AMX602, AS41A, AZ31B, AZ31C, AZ31D, AZ61A, AZ63A, AZ63B, AZ63C, AZ63D, AZ80A, AZ81A, AZ91A, AZ91B, AZ91C, AZ91D, AZ91E, AZ92A, AZ101A, AZX111, AZX211, AZX311, K1A, LA21, LA41, LA61, LA91, LA141, LZ21, LZ41, LZ61, LZ91, LZ141, LAZ941, M1A, ZC63A, ZE41A, ZEK100, ZK40A, ZK51A, ZK60A, ZK61A, and combination thereof.

In certain embodiments, the magnesium alloy foil compositionally consists essentially of AJ52A, AJ62A, AM50A, AM60A, AM60B, AM100A, AMX602, AS41A, AZ31B, AZ31C, AZ31D, AZ61A, AZ63A, AZ63B, AZ63C, AZ63D, AZ80A, AZ81A, AZ91A, AZ91B, AZ91C, AZ91D, AZ91E, AZ92A, AZ101A, AZX111, AZX211, AZX311, K1A, LA21, LA41, LA61, LA91, LA141, LZ21, LZ41, LZ61, LZ91, LZ141, LAZ941, M1A, ZC63A, ZE41A, ZEK100, ZK40A, ZK51A, ZK60A, ZK61A, and combination thereof.

In some embodiments, the magnesium alloy foil is a rolled foil.

In some embodiments, the magnesium alloy foil has a bulk electrical resistivity from about 5 to about 25 μΩ-cm.

In some embodiments, the magnesium alloy foil has an ultimate tensile strength greater than 150 MPa. The magnesium alloy foil may have an elongation to fracture greater than 0.5%, for example.

In some embodiments, the lithium-ion battery comprises an electrode/separator stack containing the negative electrode, the separator, and the positive electrode. The electrode/separator stack may be wound, folded, or flat.

In some embodiments, the positive-electrode current collector is joined to a conductive metal body (e.g., tab) via ultrasonic welding, laser welding, an adhesive, or a combination thereof. In certain embodiments, the positive-electrode current collector is mechanically joined to a conductive metal body.

In some embodiments, the positive-electrode current collector is joined to a body material comprising an additional magnesium alloy (different than the magnesium alloy in the negative-electrode current collector). In some embodiments, the additional magnesium alloy is compositionally the same as the magnesium alloy foil in the negative-electrode current collector.

In some embodiments, the positive-electrode current collector is joined to a tabbing material comprising aluminum, an aluminum alloy, iron, steel, stainless steel, nickel, copper, zinc, a zinc alloy, or a combination thereof.

In some embodiments, magnesium alloys are used in both current collectors, at both the anode and cathode sides. In some embodiments, the negative-electrode current collector comprises a second magnesium alloy foil that contains at least 50 atomic percent magnesium. The second magnesium alloy foil in the negative-electrode current collector may be compositionally the same as the magnesium alloy foil in the positive-electrode current collector.

In some embodiments using a magnesium alloy as the positive-electrode current collector, the negative-electrode current collector comprises copper or copper alloy foil.

Some embodiments provide a sealed lithium-ion battery comprising the lithium-ion battery as disclosed, with a magnesium alloy utilized at the cathode, wherein the sealed lithium-ion battery further comprises a battery casing that sealably encloses the lithium-ion battery from the environment. In some embodiments, the battery casing has a cylindrical form factor. In some embodiments, the battery casing has a rigid rectangular form factor. In some embodiments, the battery casing has a prismatic form factor. In some embodiments, the battery casing has a soft-pouch form factor.

In some embodiments, positive electrode material is mixed in a solvent and deposited onto the magnesium alloy foil. In some embodiments, positive electrode material is mixed in an alkaline aqueous solution and deposited onto the magnesium alloy foil. In some embodiments, positive electrode material is deposited via a dry process. In certain embodiments, a conductive coating is applied to the current collector prior to application of a slurry, such as an acidic graphite slurry.

The form of electrolyte is not limited. The electrolyte may generally be a liquid, a solid, a semi-solid, or a gel.

In some embodiments, the electrolyte comprises a fluorine-containing compound. The electrolyte may contain from about 10 mM to about 6 M of the fluorine-containing compound, for example.

In some embodiments, the electrolyte comprises a material selected from the group consisting of lithium bis(trifluoromethansulfonyl)imide, lithium hexafluorophosphate, lithium bis(fluorosulfonyl)imide, lithium trifluoromethane sulfonate, lithium perchlorate, and combinations thereof.

In some embodiments, the electrolyte comprises ethylene carbonate, propylene carbonate, dimethyl carbonate, diethyl carbonate, ethyl methyl carbonate, fluoroethylene carbonate, 1,2-dimethoxyethane, 1,3-dioxolane, acetonitrile, ethyl acetate, tetrahydrofuran, polyethylene oxide, or a combination thereof.

In some embodiments, the electrolyte comprises fluoroethylene carbonate, vinylene carbonate, methylene ethylene carbonate, propane sultone, biphenyl, lithium bis(oxalato)borate, lithium difluoro(oxalato)borate, lithium bis(fluorosulfonyl)imide, or a combination thereof.

Some variations of the invention utilize a bipolar battery configuration in which the negative and positive electrodes share a common current collector. A bipolar battery configuration stacks cells in series by coating the cathode and anode on opposite sides of a single current collector, allowing electrons to flow directly through the plate. This design increases voltage, reduces weight and internal resistance, and enhances energy density by eliminating external connectors. It can be highly efficient for high-power applications like electric vehicles. When a bipolar battery configuration is used, the common current collector may comprise a magnesium alloy foil containing at least 50 atomic percent magnesium. Any of the magnesium alloys, compositions, foil thicknesses, and surface properties disclosed in this specification may apply to a common current collector in a bipolar battery configuration.

Some variations of the disclosure provide a lithium-ion-battery current collector for use in transferring electrical current to or from a negative electrode in a lithium-ion battery, wherein the lithium-ion-battery current collector consists essentially of a magnesium alloy foil containing at least 50 atomic percent magnesium, wherein the lithium-ion-battery current collector is substantially copper-free, and wherein the magnesium alloy foil is characterized by:
(a) a thickness selected from about 4 μm to about 50 μm;
(b) an average roughness Rₐ selected from about 0.05 μm to about 2 μm;
(c) a root-mean-square roughness R_{q} selected from about 0.05 μm to about 3 μm;
(d) a surface roughness R_{z} selected from about 0.25 μm to about 3 μm;
(e) an areal capacity from about 2 to about 250 μAh/cm² when biased at 20 mV vs Li⁰/Li⁺ for 12 hours;
(f) a bulk electrical resistivity no greater than 25 μΩ-cm;
(g) an ultimate tensile strength greater than 150 MPa; and
(h) an elongation to fracture greater than 0.5%.

Other variations provide a lithium-ion-battery current collector for use in transferring electrical current to or from a positive electrode in a lithium-ion-battery, wherein the lithium-ion-battery current collector consists essentially of a magnesium alloy foil containing at least 50 atomic percent magnesium, wherein the lithium-ion-battery current collector is copper-free, and wherein the magnesium alloy foil is characterized by:
(a) a thickness selected from about 4 μm to about 50 μm;
(b) an average roughness Rₐ selected from about 0.05 μm to about 2 μm;
(c) a root-mean-square roughness R_{q} selected from about 0.05 μm to about 3 μm;
(d) a surface roughness R_{z} selected from about 0.25 μm to about 3 μm;
(e) a bulk electrical resistivity no greater than 25 μΩ-cm;
(f) an ultimate tensile strength greater than 150 MPa; and
(g) an elongation to fracture greater than 0.5%.

Other variations provide a lithium-ion-battery current collector for use in transferring electrical current to or from both negative and positive electrodes in a bipolar lithium-ion-battery, wherein the lithium-ion-battery current collector consists essentially of a magnesium alloy foil containing at least 50 atomic percent magnesium, wherein the lithium-ion-battery current collector is copper-free, and wherein the magnesium alloy foil is characterized by:
(a) a thickness selected from about 4 μm to about 50 μm;
(b) an average roughness Rₐ selected from about 0.05 μm to about 2 μm;
(c) a root-mean-square roughness R_{q} selected from about 0.05 μm to about 3 μm;
(d) a surface roughness R_{z} selected from about 0.25 μm to about 3 μm;
(e) a bulk electrical resistivity no greater than 25 μΩ-cm;
(f) an ultimate tensile strength greater than 150 MPa; and
(g) an elongation to fracture greater than 0.5%.

Other variations provide methods of making a lithium-ion battery. In some embodiments, a method of making a lithium-ion battery comprises:
(a) providing a negative electrode;
(b) contacting a negative-electrode current collector with the negative electrode;
(c) providing a positive electrode;
(d) contacting a positive-electrode current collector with the positive electrode;
(e) providing a lithium-containing electrolyte; and
(f) interposing a separator between the negative electrode and the positive electrode, wherein the separator is permeable to lithium ions,
wherein the negative-electrode current collector comprises a magnesium alloy foil containing at least 50 atomic percent magnesium.

In some methods, the method further comprises sealing the battery in a battery casing to create a sealed lithium-ion battery that is isolated from the environment. Preferably, the method is conducted such that the sealed lithium-ion battery contains less than 500 parts per million water by mass. Preferably, the method is conducted such that the sealed lithium-ion battery contains less than 500 parts per million oxygen by volume. Preferably, the method is conducted such that the sealed lithium-ion battery contains less than 1000 parts per million hydrofluoric acid by mass.

In other embodiments, a method of making a lithium-ion battery comprises:
(a) providing a negative electrode;
(b) contacting a negative-electrode current collector with the negative electrode;
(c) providing a positive electrode;
(d) contacting a positive-electrode current collector with the positive electrode;
(e) providing a lithium-containing electrolyte; and
(f) interposing a separator between the negative electrode and the positive electrode, wherein the separator is permeable to lithium ions,
wherein the positive-electrode current collector comprises a magnesium alloy foil containing at least 50 atomic percent magnesium.

In some methods using a magnesium alloy in the positive-electrode current collector, the method further comprises sealing the battery in a battery casing to create a sealed lithium-ion battery that is isolated from the environment. Preferably, the method is conducted such that the sealed lithium-ion battery contains less than 500 parts per million water by mass. Preferably, the method is conducted such that the sealed lithium-ion battery contains less than 500 parts per million oxygen by volume. Preferably, the method is conducted such that the sealed lithium-ion battery contains less than 1000 parts per million hydrofluoric acid by mass.

### Formation, Rolling and Morphological Properties of Magnesium Alloy Foils

Magnesium alloys may be formed by first twin-roll casting from molten metal to form 3-5 mm thick sheet which is subsequently rolled down to form the foil. Magnesium alloy sheet may be hot-rolled or warm-rolled to form foil to account for its relatively low crystal symmetry. High-temperature rolling, in excess of 250° C., of magnesium alloy foils requires the use of specially engineered work rolls that exhibit superior temperature control along their profile, with a precise crown that mitigates waviness in the final foil. Asymmetric rolling, in which the top and bottom work rolls rotate at different speeds, may also be used to reduce basal texture and increase ductility in magnesium alloys by imparting large shear forces in the foil.

A foil is defined as having a thickness of less than 200 microns. In exemplary embodiments, the magnesium alloy foil ranges in thickness from about 4 μm to about 50 μm, from about 4 μm to about 30 μm, from about 4 μm to about 20 μm, from about 4 μm to about 15 μm, or from about 5 μm to about 12 μm. Preferably, the foil thickness is uniform across the entire foil, although that is not necessary.

Conventionally, lithium-ion batteries use a copper foil that is between 5 μm and 12 μm thick. It is highly desirable for base metal alloys that have the same thickness as copper foil to provide the same (or more) volumetric energy density as copper-containing lithium-ion-battery cells.

It should also be noted that producing Mg alloy foils requires a different process and specialized tooling compared to aluminum foils. Aluminum-alloy sheets are commonly hot rolled down to 1 mm before multiple (symmetric) cold-rolling passes to obtain 5-200 m thick aluminum foils.

Exemplary magnesium alloy processing techniques to roll into foil are described in Bettles, C. and Barnet, M. (Eds.), Advances in wrought magnesium alloys: Fundamentals of processing, properties and applications, Woodhead Publishing (2012), which is hereby incorporated by reference.

The starting Mg alloy strip, alloy type, and rolling process during foil formation impact the surface roughness of the magnesium alloy foil. The surface roughness can be measured using a Keyence laser profilometer. It is known in the art that laser profilometers can measure the average roughness Rₐ, the root-mean-square (RMS) roughness R_{q}, and the peak height R_{z}. A smooth foil may minimize the coating thickness; however, some sub-micron surface roughness is desirable to increase adhesion of active materials. Smooth rollers may be used during rolling the foil to optimize surface roughness. The surface roughness can impact active material coating and contact resistance.

In exemplary embodiments, the magnesium alloy foil has an average roughness Rₐ ranging from about 0.05 μm to about 2 μm, from about 0.05 μm to about 1 μm, from about 0.05 μm to about 1 μm, or from about 0.05 μm to about 0.5 μm. In exemplary embodiments, magnesium alloy foil has a root-mean-square R_{q} roughness ranging from about 0.05 μm to about 3 μm, from about 0.05 μm to about 1.5 μm, from about 0.05 μm to about 1 μm, or from about 0.05 μm to about 0.5 μm. In exemplary embodiments, the magnesium alloy foil has a surface roughness R_{z} ranging from about 0.25 μm to about 3 μm, from about 0.25 μm to about 2.5 μm, from about 0.5 μm to about 2.5 μm, from about 0.5 μm to about 2 μm, or from about 0.5 μm to about 1.75 μm. In some embodiments, it is desirable for magnesium alloy foils to have similar Rₐ, R_{q}, and R_{z} values as for copper or aluminum foils.

### Magnesium Alloy Selection

Magnesium can be alloyed with other elements to enhance mechanical properties, reduce lithium reactivity at low potentials, and reduce galvanic corrosion, for example. Through research and development, the present inventors have found that base metal alloys that comprise at least 50 atomic percent (at %) magnesium have excellent lithium resistance, with added alloying elements improving key properties in the lithium-ion batteries. The magnesium alloy preferably comprises at least 50 at % magnesium, and more preferably at least 60 at % magnesium. In some embodiments, the magnesium alloy foil contains 50-99.8 at % magnesium, 50-99 at % magnesium, 60-99 at % magnesium, 70-99 at % magnesium, 75-99 at % magnesium, or 80-99 at % magnesium. In various embodiments, the magnesium alloy foil contains about, at least about, or at most about 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 99.5, 99.6, 99.7, 99.8, or 99.9 at % magnesium, including any intervening range.

Alloying elements can improve corrosion resistance, increase mechanical strength, and improve mechanical ductility, which is important for thin foils used in lithium-ion-battery manufacturing. In some embodiments, the magnesium alloy foil further comprises aluminum (Al), copper (Cu), lithium (Li), manganese (Mn), zinc (Zn), calcium (Ca), zirconium (Zr), silver (Ag), yttrium (Y), gadolinium (Gd), neodymium (Nd), nickel (Ni), silicon (Si), strontium (Sr), cerium (Ce), lanthanum (La), praseodymium (Pr), dysprosium (Dy), erbium (Er), samarium (Sm), ytterbium (Yb), or a combination thereof.

The magnesium alloy foil may also comprise impurity elements (that are not intended alloying elements), preferably totaling no more than about 2 wt %, more preferably no more than about 1 wt %, and most preferably no more than about 0.5 wt %. Impurity elements may be metallic or non-metallic (e.g., salt-related impurities). Exemplary impurity elements include sodium, iron, chromium, sulfur, and boron.

Magnesium is high on the galvanic scale and known to corrode in the presence of air or moisture with copper, nickel, and other metals typically used as negative-electrode current-collecting tabs. Adding small amounts of aluminum can improve corrosion resistance when joining magnesium to aluminum, and further can improve workability (i.e. ability to shape and form) during rolling. In exemplary embodiments, the magnesium alloy foil further comprises about 0.25-15 wt % aluminum, about 0.25-11 wt % aluminum, about 0.5-11 wt % aluminum, about 0.5-10 wt % aluminum, about 1-10 wt % aluminum, about 1-9 wt % aluminum, about 1-8 wt % aluminum, about 2-8 wt % aluminum, about 2.5-6 wt % aluminum, or about 2.5-4 wt % aluminum.

Zinc may be alloyed with magnesium to significantly improve corrosion resistance and to help refine grain structure to improve mechanical properties. In exemplary embodiments, the magnesium alloy foil further comprises about 0.25-10 wt % zinc, about 0.25-8 wt % zinc, about 0.2-6 wt % zinc, about 0.5-6 wt % zinc, about 0.5-4 wt % zinc, about 0.5-3 wt % zinc, or about 0.5-2 wt. % zinc.

Manganese may be alloyed with magnesium to improve corrosion resistance. In exemplary embodiments, the magnesium alloy foil further comprises about 0.01-5 wt % manganese, about 0.01-4 wt % manganese, about 0.02-3 wt % manganese, about 0.02-2 wt % manganese, about 0.05-2 wt % manganese, about 0.05-1 wt % manganese, or about 0.05-0.5 wt % manganese.

Calcium can improve oxidation resistance and refine grains in Mg alloy formation to improve mechanical properties. Calcium is also known in the art to reduce magnesium flammability. In exemplary embodiments, the magnesium alloy foil further comprises about 0.25-10 wt % calcium, about 0.25-8 wt % calcium, about 0.5-8 wt % calcium, about 0.25-5 wt % calcium, about 0.5-5 wt. % calcium, about 1-5 wt % calcium, about 0.5-3 wt % calcium, or about 1-3 wt % calcium.

Lithium can lightweight the magnesium alloy, increase ductility, and improve electrochemical stability at low potentials. In exemplary embodiments, the magnesium alloy foil further comprises about 1-20 wt % lithium, about 1-18 wt % lithium, about 1-15 wt % lithium, about 2-15 wt % lithium, about 2-12 wt % lithium, about 5-12 wt % lithium, or about 5-10 wt % lithium. Note that the lithium in the current collector is distinct from lithium participating in electrochemical reactions in a lithium-ion battery.

Copper may be alloyed with magnesium. Copper-magnesium alloys can form a solid solution, which can contribute to enhanced mechanical properties. In exemplary embodiments, the magnesium alloy foil further comprises about 0.05-10 wt % copper, about 1-10 wt % copper, about 1-7.5 wt % copper, about 2-7.5 wt % copper, about 2.5-7.5 wt % copper, about 2.5-5 wt % copper, or about 2.5-3 wt % copper.

Magnesium alloys are commonly referred to by the alloying elements and their weight percent (wt %). ASTM specification B951-11 (2025), which is hereby incorporated by reference, states that magnesium alloys are represented by two letters followed by two, three, or four numbers and a serial letter. Numbers indicate respective compositions of main alloying elements, from most to least abundant. For example, AZ31B comprises 2.5-3.5 wt % aluminum, 0.6-1.4 wt % Zn, 0.2-1 wt % manganese, and some trace (<0.05 wt %) amounts of calcium, iron, nickel, silicon, and copper, with the balance being magnesium (96 wt %).

The present invention is not limited to ASTM or any other magnesium alloy designations. For example, the alloy convention may be expanded to include other elements, such as calcium and lithium, that may historically be regarded as trace impurities but may, in the present invention, instead be intentional alloy elements. Following conventions in the industry, in this specification, ‘X’ is used to designate calcium content and “L” is used to designate lithium content.

Alloys are typically defined by the weight percentage of elements. However, weight percentages can be converted to atomic percentages by a simple calculation using molar masses. As an example, AZ31B comprises 2.1-3.3 at % aluminum, 0.1-0.6 at % zinc, 0.06-0.5 at % manganese, and some trace amounts of calcium, iron, nickel, silicon, and copper with the balance being magnesium (97 at %).

Magnesium alloys can be broadly categorized by their primary alloy element. Magnesium-aluminum alloys (e.g., AJ52A, AZ31B, AM50A, AS21A, etc.) are general-purpose alloys suitable for casting or wrought applications with a balance of strength, ductility, and corrosion resistance. Magnesium-aluminum-calcium alloys (e.g. AMX602, AZX211, etc.) have the additional benefit of high-temperature stability and ignition resistance. Magnesium-zinc alloys (e.g. ZK40A, ZEK100, etc.) offer superior strength at the cost of lower ductility. Magnesium-lithium alloys (e.g. LA91, LZ91, LAZ941, etc.) are the lightest-weight engineering material and have high ductility with generally lower corrosion resistance. Magnesium-manganese alloys (e.g. M1A, MlC) have extremely high corrosion resistance and strength. Magnesium-rare-earth alloys (e.g. EQ21A, EV31A, WE54A, etc.) have high corrosion resistance and high-temperature stability. Finally, magnesium-zirconium alloys (e.g., K1A) have high corrosion resistance and fatigue resistance, making them useful in extreme environments.

In exemplary embodiments, the magnesium alloy foil comprises AJ52A, AJ62A, AM50A, AM60A, AM60B, AM100A, AMX602, AS41A, AZ31B, AZ31C, AZ31D, AZ61A, AZ63A, AZ63B, AZ63C, AZ63D, AZ80A, AZ81A, AZ91A, AZ91B, AZ91C, AZ91D, AZ91E, AZ92A, AZ101A, AZX111, AZX211, AZX311, K1A, LA21, LA41, LA61, LA91, LA141, LZ21, LZ41, LZ61, LZ91, LZ141, LAZ941, M1A, ZC63A, ZE41A, ZEK100, ZK40A, ZK51A, ZK60A, ZK61A, or a combination thereof. A combination of Mg alloys means multiple starting alloys are combined (e.g., melted and resolidified) to form a new alloy that is not necessarily classified currently.

Magnesium alloys can be identified through x-ray diffraction (XRD) for crystal structure, energy dispersive X-ray spectroscopy (EDX) to identify the presence of most elements (except lighter elements such as lithium), and/or inductively coupled plasma (ICP) for detailed chemical analysis. These techniques are well-known in the art, and there are standard XRD references for known, ASTM-specified alloys.

It is desirable to design current collectors that are either inactive (i.e., they do not react with lithium ions in the operating window of a lithium-ion battery) or minimize reactivity to mitigate irreversible capacity loss and prevent the foil from fracturing during charging and discharging. There are several base metals and precious metals that are known in the art to electrochemically react with lithium at low potentials vs. Li⁰/Li⁺. These reactions are often referred to as alloying reactions. Metal foils of pure aluminum, tin, lead, indium, zinc, cadmium, magnesium, silver, silicon, antimony, gallium, platinum, and gold have previously been shown to electrochemically react with lithium. See Heligman and Manthiram, “Elemental Foil Anodes for Lithium-Ion Batteries”, ACS Energy Letters 6 (8), 2666-2672 (2021), and Obrovac and Chevrier, “Alloy Negative Electrodes for Li-Ion Batteries”, Chemical Reviews 114 (23), 11444-11502 (2014), the disclosures of which are incorporated by reference. The degree of reactivity with lithium can strongly depend on the morphology and crystal structure of the metal as well as the electrolyte system used, which can affect reaction kinetics and ion transport. Aluminum, tin, lead, indium, and silicon are particularly electrochemically reactive with lithium; alloys that can form phases rich in these metals are preferably avoided in negative-electrode current collectors.

It is preferred to use magnesium alloys with a silicon content as low as 0.005 at % (or even lower) since excess silicon can result in formation of a magnesium silicide phase which, in turn, can form a magnesium-silicon-lithium ternary phase upon cycling. Small amounts of silicon can cause irreversible capacity loss, while larger amounts of silicon can increase volume expansion during charging and cause the foil to crack.

Magnesium alloys with more than 40 at % aluminum can form aluminum-rich phases such as Al₃Mg₂ that can react with lithium.

Magnesium alloys preferably comprise no more than 30 at % lead, above which a lithium-reactive β-Pb phase can form.

Magnesium alloys preferably comprise no more than 30 at % tin, above which a lithium-reactive β-Sn phase can form.

Magnesium alloys preferably comprise no more than 10 at % indium, above which a potentially lithium-reactive β1 phase can form.

In order for magnesium alloy foils to be used as inactive current collectors, the foils are preferably electrochemically stable under low potentials versus Li⁰/Li⁺ (for negative-electrode current collectors), have a bulk resistivity that is within 10× of the bulk resistivity of copper, be mechanical strong (e.g., an ultimate tensile strength >150 MPa), not be brittle (e.g., elongation to fracture >2%), and be processible in battery manufacturing environments, which includes depositing active materials and joining to external bodies (e.g., tabs).

Magnesium Alloys That Do Not React at Low Potentials with Lithium

An important requirement for current collectors disclosed herein is electrochemical stability. Current-collecting foils are generally inactive materials in batteries and should be stable against oxidation and reduction environments as well as be dimensionally stable during battery charging, discharging, and storage. See Zhu et al., “A review of current collectors for lithium-ion batteries”, Journal of Power Sources 485, 229321 (2021), which is incorporated by reference.

High voltage stability is beneficial in increasing the battery energy density, which requires that cathodes and anodes have high and low electrochemical potential stability, respectively. Positive-electrode (cathode) current collectors should be stable at high voltages versus lithium. As an example, LiCoO₂ (~4 V vs Li⁰/Li⁺) cathodes are used in consumer electronics, and lithium iron phosphate (LiFePO₄, ~3.45 V vs Li⁰/Li⁺) appears to be gaining traction for electric vehicles. Graphite (0.01-0.25 V vs Li⁰/Li⁺) is currently the most widely used anode. It is challenging to keep current collectors stable in high and low electrochemical potentials. Undesirable reactions can cause capacity fade or reliability issues. See Zhang and Jow, “Aluminum corrosion in electrolyte of Li-ion battery”, Journal of Power Sources 109, 458 (2002), which is hereby incorporated by reference herein.

For negative-electrode (anode) current-collecting foils, it is desirable that the foil is electrochemically stable with lithium containing electrolyte under low potentials vs Li⁰/Li⁺. Two metrics that may determine whether current-collecting foils are electrochemically stable are: (1) lithium absorption (i.e., via intercalation, alloying, etc.) in the foil during battery cycling, and (2) volume expansion caused by lithium absorption into the foil. Lithium absorption in the current-collecting foil can deplete the lithium reservoir in the cell, causing poor coulombic efficiency and a reduction in cycle life. Lithium that alloys with or intercalates into the metal current collector, resulting in a large volume expansion, may cause mechanical fatigue and the foil to even break apart during charging or after repeated cycles. It is therefore highly desirable to minimize lithium absorption into the current-collecting foil. Furthermore, if lithium is absorbed by the metal foil, it is important that the foil experiences a volume change (either contraction or expansion) of ideally zero, or between 0.0001% to 15%, between 0.0001% to 10%, between 0.0001% to 1%, or between 0.001% to 0.5%. Lithium is known to be highly soluble in magnesium, forming a solid solution with magnesium up to 18 at % Li. Other metals (e.g., aluminum and silicon) have low lithium tolerances below 2 at % Li, above which highly stable intermetallic compounds begin to precipitate, leading to significant volume expansion in the metal.

### Use of Pure Magnesium in Current Collector

Pure magnesium foil may be utilized for the negative-electrode current collector. Pure magnesium has a lower bulk resistivity than magnesium alloys. Although pure Mg can be difficult to roll down to lower gauges, typically has inferior mechanical properties compared to Mg alloys, and can be more susceptible to corrosion than Mg alloys, there are some cases where pure Mg may nevertheless be used. For example, when exceptionally fast charging or significant lightweighting is required (e.g., for drones), cell processing and tabbing may be adjusted to accommodate for pure-magnesium foils.

In this disclosure, “pure magnesium” means at least 99 wt % magnesium, such as at least 99.9 wt % magnesium, or at least 99.99 wt % magnesium.

Some variations provide a lithium-ion battery comprising:
(a) a negative electrode;
(b) a negative-electrode current collector in contact with the negative electrode;
(c) a lithium-containing electrolyte;
(d) a separator interposed between the negative electrode and the positive electrode, wherein the separator is permeable to lithium ions;
(e) a positive electrode; and
(f) a positive-electrode current collector in contact with the positive electrode,
wherein the negative-electrode current collector comprises a foil consisting essentially of magnesium.

Certain variations provide a lithium-ion battery comprising:
(a) a negative electrode;
(b) a negative-electrode current collector in contact with the negative electrode;
(c) a lithium-containing electrolyte;
(d) a separator interposed between the negative electrode and the positive electrode, wherein the separator is permeable to lithium ions;
(e) a positive electrode; and
(f) a positive-electrode current collector in contact with the positive electrode,
wherein the positive-electrode current collector comprises a foil consisting essentially of magnesium.

### Battery Fabrication and Use

Electrochemical cells and batteries, including lithium-ion batteries, may generally be assembled according to the processes, methods, and systems set forth in Kirby W. Beard and Thomas B. Reddy, Linden's Handbook of Batteries, 5th Edition, McGraw Hill Publishers, which is hereby incorporated by reference herein.

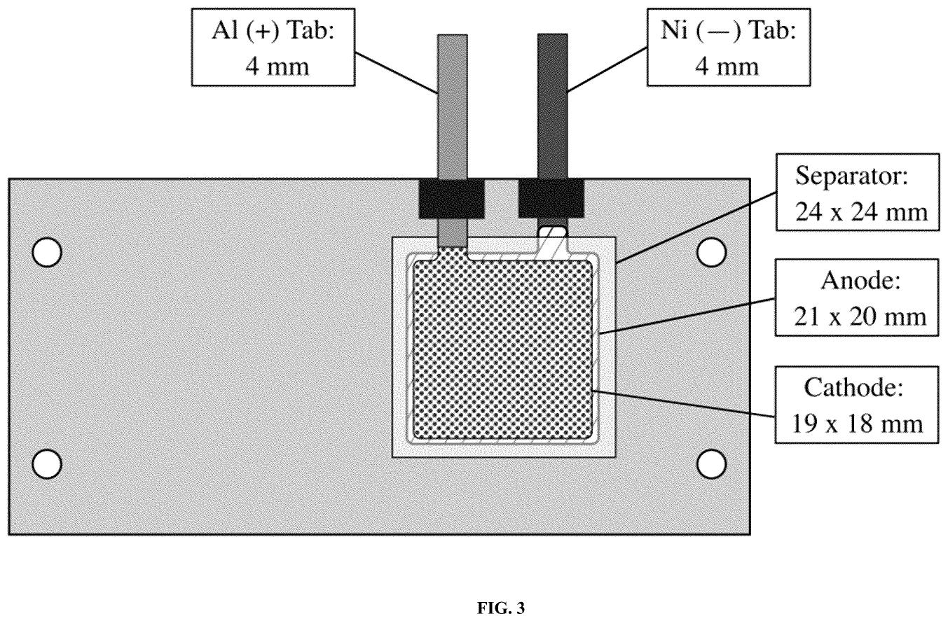

FIG. 3 depicts an exemplary cell configuration that may be used with the present invention, without limitation. In FIG. 3, a 21×20 mm anode and a 19×18 mm cathode are separated by a 24×24 mm separator. The anode consists of a negative-electrode current collector disposed on an anode layer, and the cathode consists of a positive-electrode current collector disposed on a cathode layer (see FIG. 2). Aluminum and nickel current-collecting tabs, each with 4 mm width, are used for the positive and negative terminals, respectively.

The cell may be contained in a module or pack. A module or pack generally contains a plurality of cells. The cell may be contained in an electric device, such as a portable computer or a power tool. The cell may be contained in an electric vehicle, such as (but not limited to) an electric vehicle selected from electric cars, electric trucks, electric motorcycles, electric buses, electric utility vehicles, electric airplanes, or electric locomotives.

In some embodiments, the lithium-ion battery is contained within a portable device. In some embodiments, the lithium-ion battery is contained within a smart device. In some embodiments, the lithium-ion battery is contained within a power backup system. In some embodiments, the lithium-ion battery is contained within an energy-storage system. In some embodiments, the lithium-ion battery is contained within a solar-power electricity storage system.

In some embodiments of the invention, one or more individual components (e.g., a current collector) of a lithium-ion battery are produced and then sent to another party for incorporating into a cell. In some embodiments of the invention, a cell is produced and then sent to another party for incorporating into a final device or vehicle. In some embodiments of the invention, a cell is produced and then sent to another party for incorporating into a module. In some embodiments of the invention, a module is produced and then sent to another party for incorporating into a final device or vehicle.

### EXAMPLES

### Example 1: Fabrication of Electrochemical Cells for Testing

Magnesium alloy foil reactivity can be tested with lithium at low potentials by building electrochemical cells consisting of the foil of interest as the working electrode and lithium metal as the counter electrode (half cells). Foil-lithium pouch cells were fabricated by first stacking the working electrode foil, a porous polypropylene separator, and a copper-foil current collector for lithium in an aluminum-laminate material pouch. The cells were then dried under vacuum at 100° C. for 16 hours before transferring into an argon-filled glovebox (<1 ppm O₂, <0.1 ppm H₂O). The lithium-foil counter electrodes were inserted into the cell stacks in between the polypropylene separator and copper-foil current collector inside the glovebox, after which the pouches were filled with electrolyte and heat-sealed under vacuum. The electrolyte consisted of 1.2 M LiPF₆ salt dissolved in a mixture of three parts ethylene carbonate (EC) to seven parts ethyl methyl carbonate (EMC) by weight. After filling and sealing, the cells were removed from the glovebox and placed under light compression (11 psi) to keep electrodes in contact and rested for 8 hours before testing.

### Example 2: Chronoamperometry to Measure Lithium Capacity of Current Collectors

Chronoamperometry is used to measure the lithium capacity of candidate current-collector foils. Chronoamperometry consists of applying a potential step across the electrodes and recording the resulting current vs. time behavior of the system. Foil-lithium pouch cells were constructed and then held at a potential of 0.02 V vs Li⁰/Li⁺ for 12 hours. Experiments were conducted in a temperature-controlled chamber held at 25° C. and data was recorded every 10 seconds over the course of the experiment. The current-time information obtained from these measurements provides quantitative information about the lithium capacity at electrochemical potentials and at timescales relevant to the in situ performance of anode current-collector foils. By convention, this current is plotted as negative. The measured current corresponds to the amount of lithium absorbed by the working foil, which makes the total charge passed over the course of the experiment a metric for the effective capacity of the foil electrode. The integrated current normalized by the foil active area gives the chronoamperometry areal capacity, which can be used to evaluate the theoretical capacity that the current collector would contribute. An ideal current collector contributes no lithium capacity and does not react with lithium.

### Example 3: Sputtered Magnesium Alloys Tested by Chronoamperometry

In this example, combinatorial sputtering was used to create magnesium alloys with varying Mg content from about 10 at % Mg to about 90 at % Mg. Sputtering was performed onto a glass substrate for all alloys in this Example 3. The sputtering is a physical-vapor deposition that coats the glass surfaces with ultra-thin metal films (film thickness is 1 micron for all films in this example) by ejecting Al and Mg metal atoms from target materials using energetic ions in a vacuum.

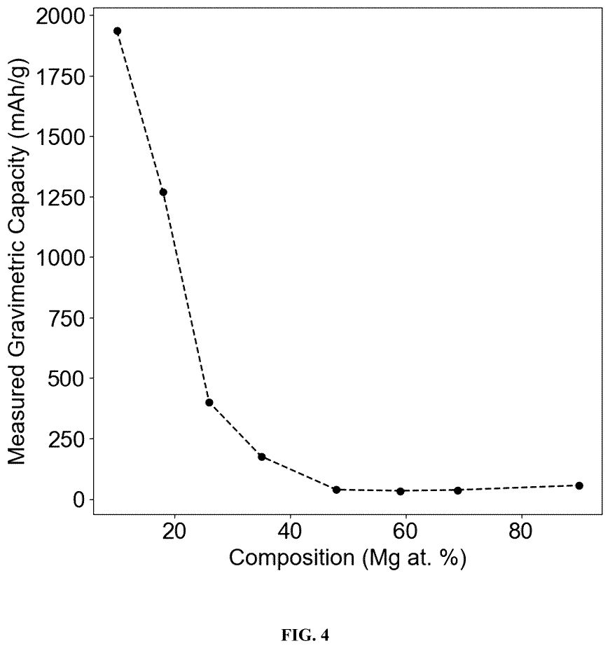

All alloys in this example were tested by chronoamperometry as described in Example 2. FIG. 4 is a graph of the gravimetric capacity (mAh/g) as a function of atomic percent of magnesium, with the balance being aluminum, and a fixed alloy thickness (1 μm). Relatively pure Al samples strongly reacted with lithium, resulting in >1750 mAh/g of lithium capacity. With increasing Mg content, there was a reduction in gravimetric capacity until the reaction is essentially shut down at approximately 50 atomic percent Mg, according to FIG. 4. The gravimetric capacity at higher Mg loadings is similar to copper foil, which is considered to be an inactive material in a lithium-ion battery.

This example determined the minimum required magnesium content to shut down lithiation at low potentials versus Li⁰/Li⁺, by measuring gravimetric capacity (mAh/g) via chronoamperometry. It was found that about 50 at % Mg is the minimum magnesium content. Magnesium alloys such as AZ31B contain >95.6 at % magnesium, which (according to the results in FIG. 4) is sufficient to prevent lithium absorption during lithium-ion battery charging.

### Example 4: Cyclic Voltammetry to Measure Electrochemical Stability of Current Collectors

It is instructive to compare magnesium alloy foils to copper and aluminum foils, which are commonly used as current collectors in LIBs. One way to compare is using cyclic voltammetry. Cyclic voltammetry is a commonly used electrochemical technique which is useful in determining whether base metal alloys are suitable for use as negative-electrode current collectors. Cyclic voltammetry is a potentiodynamic, electrochemical measurement technique performed with a potentiostat (e.g., Biologic VMP3) in which a working electrode's potential is ramped linearly versus time between two voltage limits in both forward and reverse directions, while monitoring the resulting current. The resulting current-potential plot (cyclic voltammogram) exhibits characteristic peaks corresponding to oxidation and reduction processes, providing information about electrochemical reaction reversibility, reaction mechanisms, and electron-transfer kinetics. Peak positions and distances reveal thermodynamic and kinetic information about the electrochemical processes in the system. Cyclic voltammetry allows for investigation into the electrochemical reactions (if any) governing lithium insertion and extraction for base-metal current-collector systems. See Myung et al., “Electrochemical behavior of current collectors for lithium batteries in non-aqueous alkyl carbonate solution and surface analysis by ToF-SIMS”, Electrochimica Acta 55, 288 (2009), which is incorporated by reference.

To conduct cyclic voltammetry experiments in these Examples, current-collector foil vs. lithium metal Swagelok-style half-cells were constructed. The electrolyte used in the cells was 1.2 M LiPF₆ in EC and EMC at a 3:7 gravimetric ratio. Cyclic voltammetry sweeps were conducted between 5 mV and 1.5 V at a scan rate of 1 mV/s. The voltage limits were selected to be similar to the experienced operational range of negative-electrode current collectors within a lithium-ion battery. A lower cutoff of 5 mV was selected to avoid metallic lithium plating at 0 V which could add confounding signals. Cyclic voltammetry was used to screen the electrochemical reactivity of base metal alloys for current-collector applications. Cyclic voltammetry can also be used to identify whether magnesium-containing alloys are used in a lithium-ion battery.

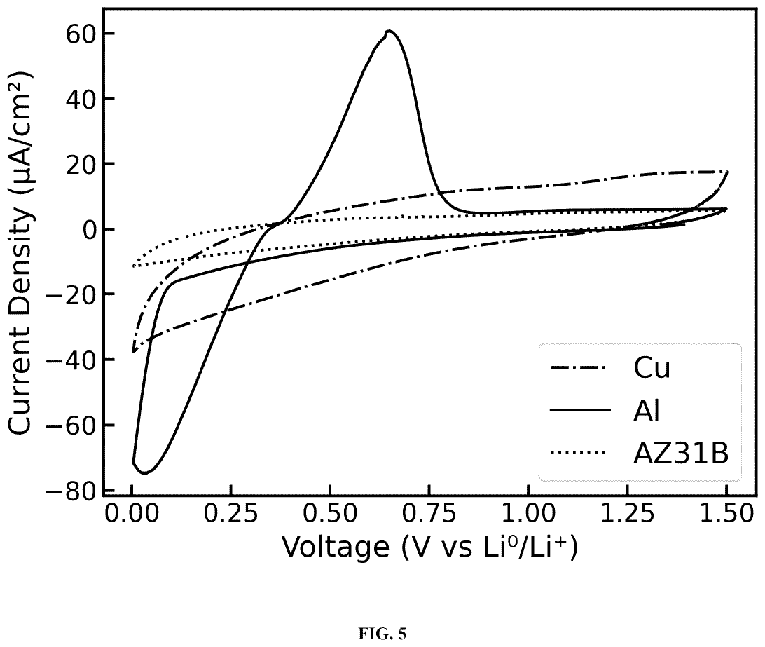

FIG. 5 shows a cyclic voltammogram of 6-micron-thick, battery-grade (i.e. pure, electrodeposited) copper foil (dash-dot line). The copper foil was placed in a lithium Swagelok-style half-cell as the working electrode with a lithium foil counter electrode. The cell was filled with an electrolyte consisting of 1.2 M LiPF₆ in EC and EMC (3:7 gravimetric ratio) and was sealed in an argon-filled glovebox (<1 ppm O₂, <0.1 ppm H₂O). There are no major anodic or cathodic peaks present in the copper voltammogram. There is a broad feature between 0.5 V and 1 V in the oxidative current (positive current) that could be attributed to trace electrochemically active copper oxides on the surface. The lack of significant electrochemical reaction peaks in the cyclic voltammogram indicates that copper is electrochemically stable at the potentials experienced by negative-electrode current collectors in full cells.

FIG. 5 also shows a cyclic voltammogram of a 12-micron-thick, battery-grade aluminum foil (solid line). The Al foil was placed in a lithium Swagelok-style half-cell as the working electrode with a lithium-foil counter electrode. The cell was filled with an electrolyte consisting of 1.2 M LiPF₆ in EC and EMC (3:7 gravimetric ratio) and was sealed in an argon-filled glovebox (<1 ppm O₂, <0.1 ppm H₂O). As shown in FIG. 5, the aluminum voltammogram is dominated by two large peaks corresponding to the alloying and dealloying of lithium. The reductive peak beginning at about 0.3 V vs Li⁰/Li⁺ is attributed to electrochemically driven lithium-aluminum alloying. The lithium-aluminum alloy system consists of numerous phases such as β-LiAl, Li₃Al₂, Li₂₋ₓAl, and Li₉Al₄ with varying gravimetric capacities of ~993 mAh/g, ~1490 mAh/g, ~1986 mAh/g, and ~2234 mAh/g, respectively, and with varying degrees of reversibility. Alloying results in a 100% volume expansion, greatly stressing the foil upon lithiation. See Zheng and Boles, “Lithium aluminum alloy anodes in Li-ion rechargeable batteries: past developments, recent progress, and future prospects”, Prog. Energy 5, 032001 (2023), which is incorporated by reference. The oxidative peak at 0.65 V is the corresponding dealloying peak, where lithium is dealloyed from the formed lithium-aluminum phases. Extracting lithium from the structure leaves behind a porous matrix of aluminum; the volume expansion experienced during alloying is largely irreversible. When cycled in a full lithium-ion cell as the negative-electrode current collector, the repetitive strain from alloy-dealloy cycles ultimately mechanically destroys the foil-resulting in loss of electrical contact, rapid capacity fade, and mechanical failure.

FIG. 5 also shows a cyclic voltammogram of 30 micron-thick AZ31B alloy foil (dotted line), which nominally contains 3 wt % Al and 1 wt % Zn, with the balance being magnesium. The foil was placed in a lithium Swagelok-style half-cell as the working electrode with a lithium-foil counter electrode. The cell was filled with an electrolyte consisting of 1.2 M LiPF₆ in EC and EMC (3:7 gravimetric ratio) and was sealed in an argon-filled glovebox (<1 ppm 02, <0.1 ppm H₂O). According to FIG. 5, the cyclic voltammogram is qualitatively similar to that of copper, with no visible reaction peak in either the cathodic direction or the anodic direction sweeps. The average current densities in both directions (−4 μA/cm² average reductive current, 3.5 μA/cm² average oxidative current) are lower than that of the 6 μm copper foil (−12 μA/cm² average reductive current, 10 μA/cm² average oxidative current). The higher current densities of 6 μm copper can be attributed to electrochemically active copper oxide on the surface of the foil.

Overall, AZ31B shows no electrochemical reaction over the probed voltage range in the cyclic voltammogram of FIG. 5, thereby demonstrating its stability for use as a negative-electrode current collector. There is no evident electrochemical activity from the 3 wt % aluminum present in AZ31B, indicating that in low Al quantities the reactivity of aluminum is suppressed and does not show any detectible electrochemical reaction.

### Example 5: Chronoamperometry of AZ31B Alloy Versus Copper and Aluminum

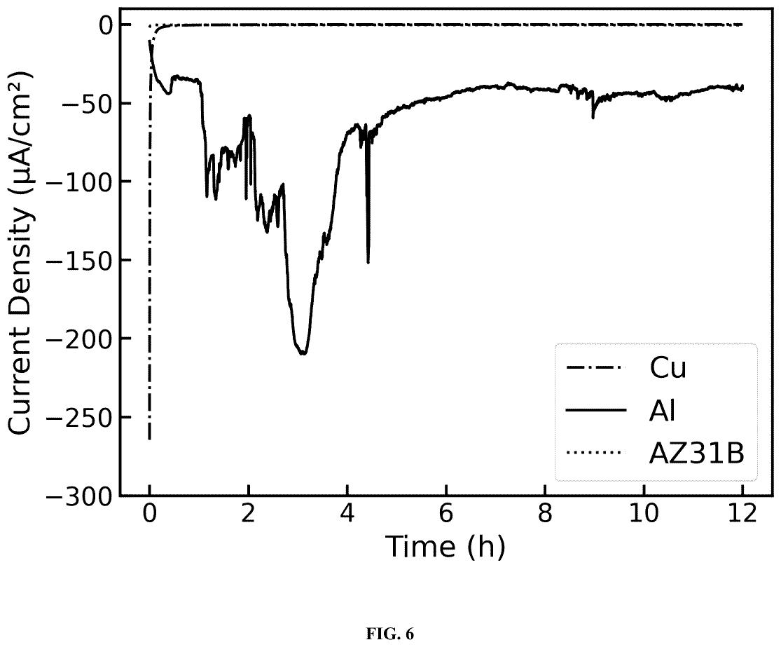

FIG. 6 shows the chronoamperometry current for the copper foil (dash-dot line) over the course of a 12-hour hold at 20 mV vs Li⁰/Li⁺. During the chronoamperometry test, the current first peaked at −265 μA/cm² before rapidly dropping to a steady-state current of roughly −0.3 μA/cm² within 20 minutes. This initial transient current is attributed to trace copper oxide on the surface, which has a capacity of 670 mAh/g. See Zhang et al., “A new lithium-ion battery: CuO nanorod array anode versus spinel LiNi_{0.5}Mn_{1.5}O₄ cathode”, J. Power Sources 273, 561-565 (2015), which is incorporated by reference. The absolute 12-hour chronoamperometry areal capacity of copper foil is measured as 5.7 μAh/cm². This capacity represents negligible electrochemical activity, consistent with copper's proven performance as the conventional negative-electrode current collector in commercial lithium-ion cells.

FIG. 6 also shows the chronoamperometry current for the aluminum foil (solid line) over the course of a 12-hour hold at 20 mV vs Li⁰/Li⁺. The absolute current density over the course of the chronoamperometry peaks at −210 μA/cm². The peak absolute current density for aluminum is higher than for AZ31B (−2 μA/cm²). While the aluminum peak absolute current density is lower than that of Cu (−265 μA/cm²), the aluminum peak current density is not a transient effect, with much more time spent at larger current densities. The average current for the 12 μm aluminum chronoamperometry hold was −63 μA/cm², compared to −0.38 μA/cm² for 30 μm AZ31B and −0.48 μA/cm² for 6 μm copper. The areal capacity calculated over the course of the 12-hour chronoamperometry hold for 12 μm battery-grade aluminum foil was >760 μAh/cm². This calculated capacity is an underestimate of the true areal capacity, because the foil loses active area as the aluminum is consumed by the alloying reaction. The current density over the course of the aluminum chronoamperometry hold was not stable, due to the previously discussed (cf. Example 4) volume expansion and subsequent morphology evolution due to the aluminum-lithiation reaction.

FIG. 6 also shows the chronoamperometry current for the AZ31B foil (dotted line) over the course of a 12-hour hold at 20 mV vs Li⁰/Li⁺. Note that much of the dotted line for AZ31B is co-existent with the dash-dot line for copper. The absolute peak current density for magnesium alloy is much lower compared to the 12 μm aluminum (−2 μA/cm² for 30 μm AZ31B versus −210 μA/cm² for 12 μm aluminum). The absolute peak current density of AZ31B is also lower than that of 6 μm battery-grade copper foil (−2 μA/cm² for 30 μm AZ31B versus −265 μA/cm² for 6 μm Cu). The initial current density change was smaller for AZ31B compared to copper, presumably due to the lack of trace electrochemically active oxide on the surface. The average current densities were similar between AZ31B and copper: −0.38 μA/cm² for 30 μm AZ31B and −0.48 μA/cm² for 6 μm copper.

The chronoamperometry areal capacity of 30 μm AZ31B was found to be 4.6 μAh/cm², significantly lower than that of 12 μm aluminum (760 μAh/cm²), when biased at 20 mV vs Li⁰/Li⁺ for 12 hours. The measured capacity of 4.6 μAh/cm² for AZ31B is comparable to that of copper (5.7 μAh/cm²), when biased at 20 mV vs Li⁰/Li⁺ for 12 hours. The measured chronoamperometry areal capacity demonstrates AZ31B's potential as an improved negative-electrode current collector.

### Example 6: Imaging of AZ31B, Copper, and Aluminum Current Collectors Before and After Chronoamperometry

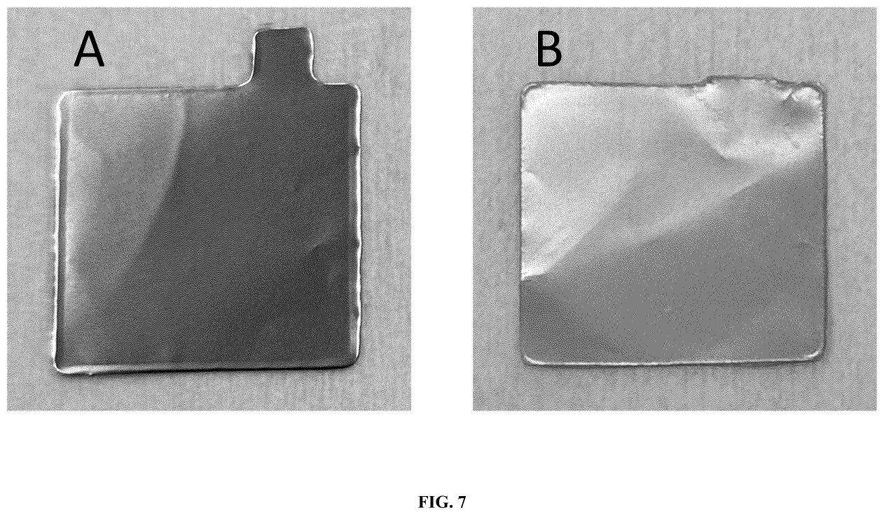

FIG. 7 shows a photographic image of the copper foil before (image A) and after (image B) the 12-hour chronoamperometry hold described in Example 5. There is no visible sign of reaction or degradation of the copper foil.

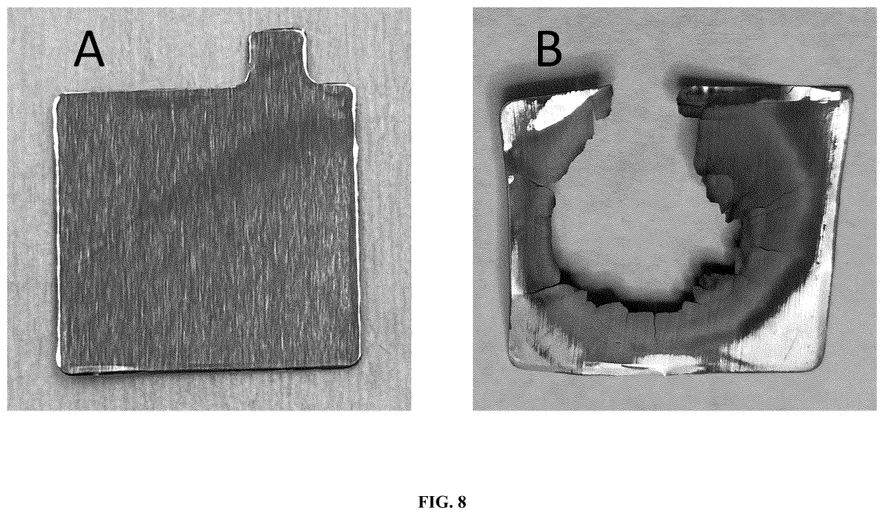

FIG. 8 shows a photographic image of the aluminum foil before (image A) and after (image B) the 12-hour chronoamperometry hold described in Example 5. Image B in FIG. 8 shows that the center of the foil electrode opposite the lithium chip obviously reacted and was damaged from the volume expansion during lithium alloying. Aluminum foils are not typically used as the negative-electrode current collector because aluminum reacts with lithium at low potentials (e.g., 300 mV vs Li⁰/Li⁺), forming a lithium-aluminum alloy and mechanically damaging the foil.

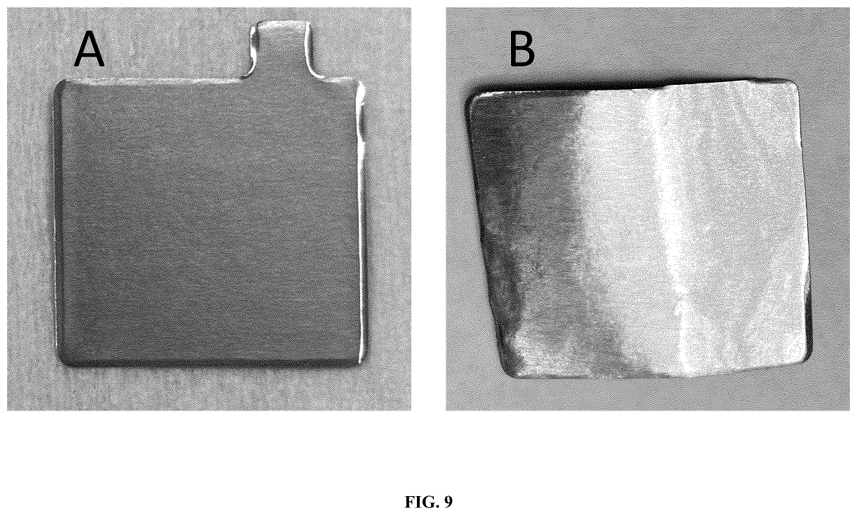

FIG. 9 shows a photographic image of the AZ31B magnesium alloy foil before (image A) and after (image B) the 12-hr chronoamperometry hold described in Example 5. There is no visible reacted area in image B of FIG. 9.

### Example 7: Impact of Current-Collector Electrical Resistivity on Lithium-Ion-Battery Performance and Cell Design

Four-point electrical measurements can be used to determine the bulk resistivity of a metal foil with a known thickness. The Van der Pauw method is a standard measurement technique for homogenous foils of arbitrary shape. See van der Pauw, “A method of measuring specific resistivity and Hall effect of discs of arbitrary shape” Philips Research Reports 13:1-9, 1958, which is incorporated by reference.

The metal foil thickness was measured using a precision micrometer. The metal foil was cut into 20 mm×20 mm squares, and four electrical probes were placed at the corners of a square. A 2410 Keithley SourceMeter applying a 1 A current was combined with a multiplexer to determine the resistance along each edge of the sample. The measured resistances were inserted into the Van der Pauw equation to calculate the sheet resistance. The sheet resistance multiplied by the thickness determines the bulk resistivity of the metal foils. Using this approach, Table 1 lists the measured bulk resistivities of copper, aluminum, magnesium, AZ31B, AZX211, and LZ141 foils.

It is important to minimize the bulk resistivity of magnesium alloy foils to minimize the series resistance caused by the current collector. Copper foil is known to have a bulk resistivity of 1.8 μΩ-cm, which is the lowest bulk resistivity of any non-precious metal. The low bulk resistivity of copper is often cited as the primary reason why copper is used for anode current collectors, but this is not generally true.

TABLE 1
Bulk Resistivity of Metal Foils in Example 7

| Material | Foil Thickness (μm) | Resistivity (μΩ · cm) |
|---|---|---|
| Copper | 10 | 1.8 |
| Aluminum | 15 | 3.1 |
| Magnesium | 55 | 5.6 |
| AZ31B | 35 | 9.0 |
| AZX211 | 100 | 7.1 |
| LZ141 | 35 | 17.7 |

In general, current collectors are not a primary contributor to the series resistance of batteries. Many commercial cell architectures are not optimized to reduce foil-related resistances. As an example, many “blade” cells are over 0.5 m long and tabbed at the short end of the cells to reduce cell volume. This design results in cells with significant (>25%) series resistance contribution from the current collectors. It is possible for a “blade” cell to tab along the long end of the cell significantly reducing series resistance from the current collector, but this is not required to meet electric vehicle customer specifications. Doyle-Fuller-Newman electrochemical modeling indicates that large-format (e.g., 100 Ah) cells used in automotive applications can operate at charge rates greater than 5 C when using foils with a bulk resistivity between 5× and 10× higher than copper foil.

The bulk resistivity of magnesium alloys can be tuned by the alloying elements and processing conditions (e.g., tempering). For example, the AZ31B foil has a bulk resistivity of 9.0 μΩ-cm, which is 5× more resistive than bulk copper foil. Magnesium alloy foil with a resistance of 9 μΩ-cm is sufficient as a drop-in replacement in cylindrical, pouch, and prismatic formats in lithium-ion batteries.

### Example 8: Measurement and Optimization of Mechanical Properties for Current-Collecting Foils in Lithium-Ion Batteries

It is desirable for metal foils to have a certain degree of ductility and strength in order to be used in high-throughput battery manufacturing lines. It is desirable to form the magnesium alloy foils via rolling, which is a high-throughput manufacturing method that requires relatively little capital cost compared to electrodeposition. Brittle metal alloys are difficult to roll to thin gauges, so elongation and workability can be extremely important.

Secondly, it is highly desirable for the metal foil to possess high ultimate tensile strength (e.g., >200 MPa), high yield strength (e.g., >150 MPa), and high elongation (e.g., >2%) to work with sophisticated web drive systems that have been developed to handle thin foils (e.g., 6-12 μm thick). Sufficient tensile strength and ductility are also important for foils to survive the mechanical stresses of the cell-winding process and repeated expansion and contraction cycles of the active material during battery cycling.

This example analyzes two magnesium alloys, AZ31B (without and with heat treatment) and LZ141. Mechanical properties were measured via stress-strain tensile testing. Type A dogbone specimens were die cut according to ASTM Standard E345-24a, which is incorporated by reference. A Mark-10 ESM303 motorized test stand equipped with wedge grips and a Mark-10 M5-50 force gauge was used to pull the samples with a strain rate of 0.005 per second. At least five samples were tested per material to determine each mechanical property.

TABLE 2
Mechanical Properties of Current-Collecting Foils

| | Foil | Ultimate | Yield | |
|---|---|---|---|---|
| | Thickness | Tensile Strength | Stress | Elongation-at- |
| Material | (μm) | (MPa) | (MPa) | Failure (%) |
| Copper | 10 | 286 | 242 | 3.4 |
| Aluminum | 15 | 154 | 147 | 1.8 |
| AZ31B | 35 | 239 | 200 | 4.0 |
| LZ141 | 35 | 169 | 150 | 2.8 |

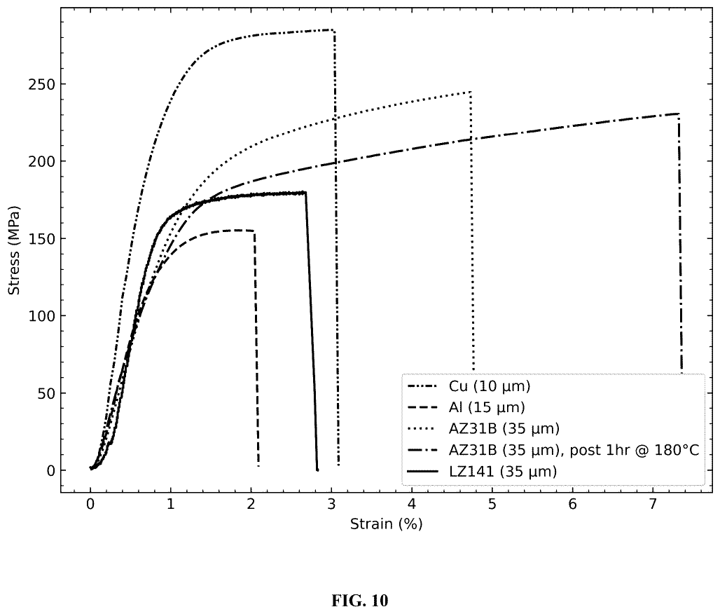

FIG. 10 shows the stress-strain curves of a 10-μm-thick copper foil (dash-dot-dot line), 15-μm-thick aluminum foil (dashed line), a 35-μm-thick magnesium alloy AZ31B foil (dotted line), and a 35-μm-thick magnesium alloy LZ141 foil (solid line). According to FIG. 10, the AZ31B magnesium alloy foil is significantly stronger than aluminum foil and comparable to copper foils. The AZ31B magnesium alloy foil is also quite ductile and has an elongation-to-failure of over 4%. Thermally annealing the AZ31B magnesium alloy foil at 180° C. for 1 hour can increase elongation-to-failure beyond 7% as shown in FIG. 10 (dash-dot line).

Table 2 lists the mechanical properties based on the stress-strain curves in FIG. 10.

### Example 9: Lithium-Ion-Battery Cell Processing and Material Requirements for Current-Collecting Foils

Lithium-ion batteries can be fabricated in a wide variety of formats including coin cells and single-layer pouch cells to initially test performance with new materials. For automative and energy-storage application, larger-format lithium-ion batteries can be fabricated as wound, cylindrical, or prismatic cells. Typical lithium-ion battery architecture uses a stack containing a negative-electrode current collector coated with active material, a polymer or composite separator soaked in a lithium-containing electrolyte, and a positive-electrode current collector coated with active material. These stacks can be repeated to create multiple-layer cells.

Positive-electrode active materials may include lithium iron phosphate LiFePO₄ (LFP), lithium manganese iron phosphate LiMnₓFe₁₋ₓPO₄ (LMFP), lithium cobalt oxide LiCO₂ (LCO), lithium nickel manganese cobalt oxide LiNiₓMn_{y}Co_{z}O₂(NMC), lithium nickel cobalt aluminum oxide LiNiₓCo_{y}Al_{z}O₂ (NCA), mixtures thereof, or other active materials known in the art. Positive-electrode active materials are generally deposited on metal-foil current collectors and dried to form the positive-electrode current collector coated with active material. Positive electrodes may be calendered to achieve a final target density and porosity. Exemplary details on methods of positive-electrode fabrication can be found in Apachitei et al., “Optimisation of Industrially Relevant Electrode Formulations for LFP Cathodes in Lithium Ion Cells”, Batteries 9, 192 (2023), which is incorporated by reference.

Negative-electrode active materials may include graphite, lithium titanate Li₄Ti₅O₁₂ (LTO), hard carbon, silicon, mixtures thereof, or other active materials known in the art. Negative electrodes can also be composed of lithium metal that is either bonded mechanically to the current collector, physically deposited on the current collector ex situ, or electrochemically deposited in situ. Graphite is commonly used in negative-electrode active materials of commercial lithium-ion batteries because graphite is widely available, relatively inexpensive, and can achieve high capacity after many cycles. Silicon has significantly higher lithium capacity than graphite but also undergoes 300% volume expansion when alloyed with lithium. Small quantities (e.g., up to 5 wt %) of silicon-based particles may be mixed in graphite to increase the volumetric energy density of the battery. The negative electrode may comprise a majority of silicon. Lithium titanate has a lower lithium capacity than graphite but is extremely stable and can be charged at high rates. Lithium metal has a very high energy density, but it can be challenging to prevent lithium dendrite formation over repeated cycles.

Active materials can be formulated with organic binders to improve particle cohesion and film adhesion to the current collector. Binders may include carboxymethyl cellulose (CMC), styrene-butadiene rubber (SBR), polyacrylic acid (PAA), polyvinyl alcohol (PVA), polyethylene oxide (PEO), polyvinylidene fluoride (PVDF), polytetrafluoroethylene (PTFE), mixtures thereof, or others binders are known in the art.

Also, active materials can be formulated with conductive additives to improve electron conduction through the thickness of the electrode. Conductive additives may include carbon black, single-walled carbon nanotubes, multi-walled carbon nanotubes, graphene, acetylene black, mixtures thereof, or other conductive additives known in the art.

To facilitate coating an electrode material on the current collector, electrode materials can be combined with a solvent, such as N-methyl-2-pyrrolidone (NMP) and/or water, to form a slurry. The negative electrode may comprise graphite active material and less than 10 wt % of carbon black and PVDF. The negative electrode active material may comprise graphite active material and less than 10 wt % of carbon black and a combination of CMC and SBR. The negative electrode active material may comprise graphite active material and less than 10 wt % of carbon black and PTFE. The positive electrode may comprise LFP active material and less than 10 wt % carbon black and PVDF. The positive electrode may comprise NMC active material and less than 10 wt % carbon nanotubes and PVDF.

Electrode coating can utilize any coating technique known in the art, including slot-die coating, doctor-blade coating, or other wet-coating methods. Alternatively, electrodes can be coated without being dissolved in a solvent (often referred to as dry-coating). Dry-coating methods known in the art can include electrostatic spray coating followed by hot rolling, and dry extrusion of a blend of electrode materials comprising a binder (e.g., a fibrillating PTFE binder) followed by hot lamination to the current-collector foil.

Graphite may be wet-coated from a slurry comprising graphite, conductive additive, and CMC-SBR binder dispersed in water with a pH between 3 and 8 when using copper foil as the negative-electrode current collector. Magnesium alloy foils are higher on the galvanic scale compared to aluminum and copper foils, so Mg alloy foils can corrode with exposure to acidic aqueous conditions. If an acidic graphite slurry is cast onto a magnesium-containing base alloy foil, corrosion can cause hydrogen bubbles to form, resulting in pinholes in the coating, poor adhesion of the electrode material to the current collector, and consequently poor electrode quality. To avoid reaction with magnesium alloys, electrode materials may be dispersed in NMP or a higher pH aqueous solution, or may be dry-coated.

In this example, experiments were conducted to deposit active material from a slurry comprising graphite active material, less than 10 wt % carbon black, and a combination of CMC and SBR, dispersed in water. The slurry was pH-adjusted to a pH of 12 using sodium hydroxide before wet-coating the negative electrode onto a magnesium alloy foil.

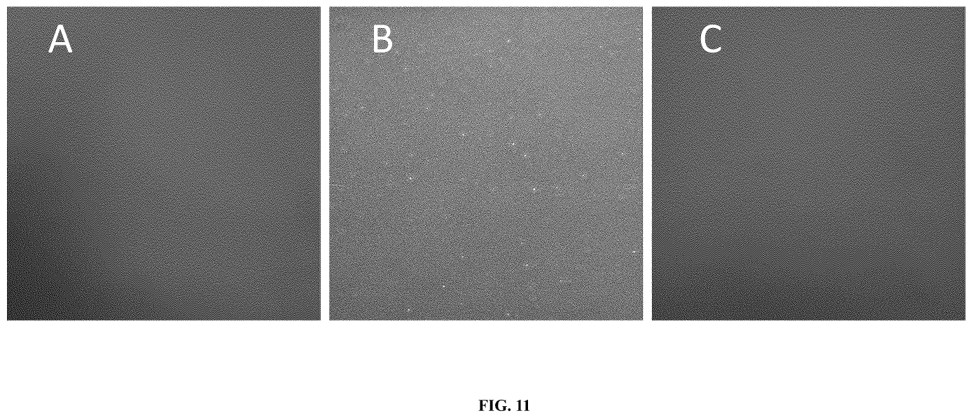

FIG. 11 shows photographic images of graphite slurries comprising PVDF binder in NMP (image A), CMC-SBR binder in a pH 7 aqueous solution (image B), and CMC-SBR binder in a pH 12 aqueous solution (image C) cast on magnesium alloy AZ31B foil and subsequently dried. The NMP and pH 12 aqueous slurry formulations resulted in densely coated graphite that adheres well to the magnesium alloy substrate. However, the pH 7 aqueous slurry resulted in a graphite layer that exhibited pinholes, poor adhesion, and poor performance in lithium-ion batteries.

Electrolytes in common lithium-ion batteries are generally a liquid, but electrolytes may be solid, semi-solid, or gel. Liquid and gel electrolytes are typically comprised of a lithium salt dissolved in a polar solvent. Lithium salts may include lithium hexafluorophosphate (LiPF₆), lithium bis(trifluoromathansulfonyl)imide (LiTFSI), lithium bis(fluorosulfonyl)imide (LiFSI), lithium trifluoromethane sulfonate (LiOTf), lithium perchlorate (LiClO₄), a combination thereof, or other lithium salts known in the art. Polar solvents may include ethylene carbonate (EC), propylene carbonate (PC), dimethyl carbonate (DMC), diethyl carbonate (DEC), ethyl methyl carbonate (EMC), fluoroethylene carbonate (FEC), 1,2-dimethoxyethane (DME), 1,3-dioxolane (DOL), acetonitrile (ACN), ethyl acetate (EA), tetrahydrofuran (THF), polyethylene oxide (PEO), a combination thereof, others polar solvents known in the art. The electrolyte may further contain additives such as fluoroethylene carbonate (FEC), vinylene carbonate (VC), methylene ethylene carbonate (MEC), propane sultone (PS), biphenyl (BP), lithium bis(oxalato)borate (LiBOB), lithium difluoro oxalato borate (LiDFOB), lithium bis(fluorosulfonyl)imide (LiFSI), a combination thereof, or other electrolyte additives known in the art.

Separators are used to electronically isolate the positive and negative electrodes from each other and to conduct lithium ions. Separators may comprise a porous polymer film, a porous or ion-conducting ceramic body, a glass fiber sheet, or a composite thereof, or other separators known in the art. An exemplary separator is monolayer microporous polypropylene membrane. Another exemplary separator is a trilayer microporous membrane comprising polypropylene and polyethylene.

During fabrication of a lithium-ion battery, an electrode/separator stack is formed from the positive electrode, at least one separator, and the negative electrode before being filled with electrolyte. For low-capacity batteries (<500 mAh), a single stack can be used with the current collectors coated with active material only on one side. Examples of this architecture include coin or button cells (such as commonly used CR2016 and CR2032 cells), or single-layer pouch cells. For larger capacity batteries (>500 mAh), it is preferred for the current collectors to be coated on both sides and then stacked with alternating layers of negative electrode and positive electrode, with at least one separator layer between each electrode layer. This structure can be formed by individual sheets of electrodes/separator stacked on top of each other, or by continuous strips of electrode material and separator that are stacked and then folded to form multiple stacked layers. These strips of electrode material may be stacked and then wound into a cylinder or elliptic cylinder, typically referred to as a “jelly roll”.

Electrode stacks may be contained inside casings made of rigid or flexible materials. These casings sealably enclose the electrode stack from the environment, preventing electrolyte evaporation and exposure of the electrode stack to oxygen and moisture. Eliminating exposure to oxygen and moisture is important for magnesium alloy foils to prevent corrosion which can increase interfacial resistivity, reducing cell efficiency. These casings can take several form factors, including rigid cylinders or cans typically made of steel or aluminum alloys, prismatic or rectangular casings typically made of steel or aluminum alloys, or soft pouch casings typically made of a polymer-coated aluminum. These casings can contain one or more electrode stacks or jelly rolls. Each electrode is typically electrically connected through the casing to allow the flow of electrical current. This configuration can be achieved by directly connecting the positive-electrode current collector to a positive terminal and the negative-electrode current collector to a negative terminal inside the casing, with the positive and negative terminal always electronically isolated. Optionally, a portion of the casing may serve as the terminal for electrical connection. Electrical contact can be achieved with electrically conductive metal bodies known as “tabs” extending out of the casing. Common methods for joining the current collector to tab or terminal materials include laser welding, ultrasonic welding, mechanical clamping, and taping (use of an adhesive). In certain cell formats, it is possible to cut the ends of the current collectors in a way to interleave them at the end of the electrode to form a “tabless” design that is connected to the corresponding terminal. The negative-electrode current collector (the magnesium alloy foil) may be joined via ultrasonic welding to a conductive metal body (tabbing or terminal). The negative-electrode current collector (magnesium alloy foil) may be joined via laser welding to a conductive metal body (tabbing or terminal). The negative-electrode current collector (magnesium alloy foil) may be joined via tape to a conductive metal body (tabbing or terminal). The negative-electrode current collector (magnesium alloy foil) may be joined mechanically to a conductive metal body (tabbing or terminal).

Metal compatibility should be considered for the foil joining to conductive metal bodies (e.g., tabs or terminals). Conductive metal bodies used as tabbing or terminal layers typically include nickel, copper, or nickel-coated copper for a copper-foil current collector, and typically include aluminum or chromium-coated aluminum for an aluminum-foil current collector. Galvanic corrosion between current collectors and tab/terminal materials is known to occur in lithium-ion batteries with long-term exposure to electrolyte—particularly if any moisture is present. Tabs comprising nickel are often used with copper current collectors to improve weld quality and prevent corrosion of the copper in contact with electrolyte. Magnesium alloys can be more susceptible to corrosion, particularly when in contact with more-noble metals such as nickel and in the presence of trace moisture, oxygen, or acids. Therefore, tabs or terminals that are substantially nickel-free (<0.10 wt % Ni) can be preferred for magnesium-alloy current-collector foils that connect to those tabs or terminals.

### Example 10: XRD and EDX Analysis of AZ31B Mg Alloy Foil

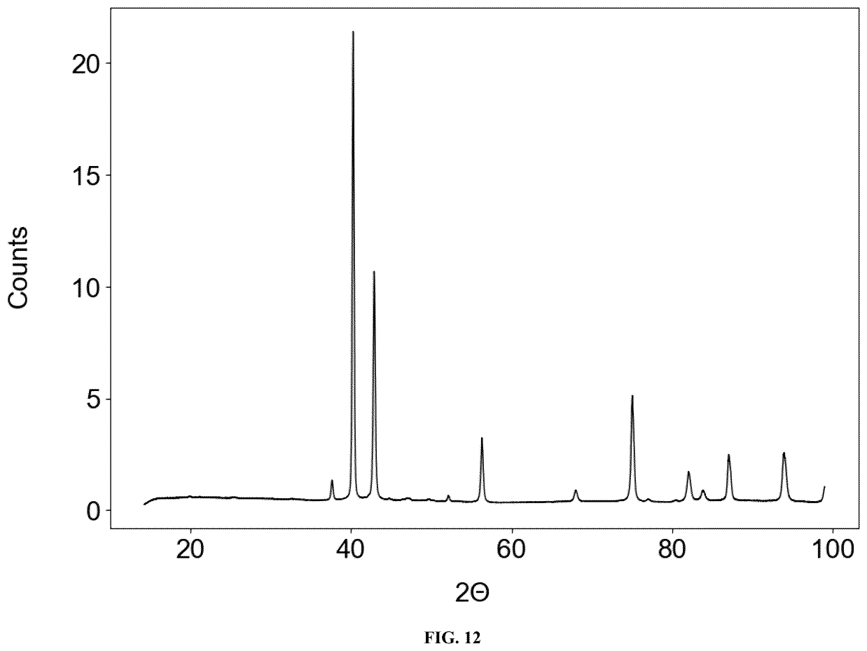

XRD was performed using a Bruker ZXS D8 Discover GADDS X-ray diffractometer equipped with a VANTEC-500 area detector and a cobalt X-ray source operated at 35 kV and 40 mA. Diffractograms were measured using cobalt Kα wavelength in four 250 frames that were combined for a total window of 15-100° in 20. Each frame was measured for 5 minutes under X-ray irradiation. FIG. 12 is a XRD diffractogram of magnesium alloy AZ31B foil. According to FIG. 12, the AZ31B foil has prominent peaks at 20 values of 40°, 43°, 56°, 75°, 87°, and 94°, indicative of the hexagonal close-packed crystal structure of the AZ31B alloy.

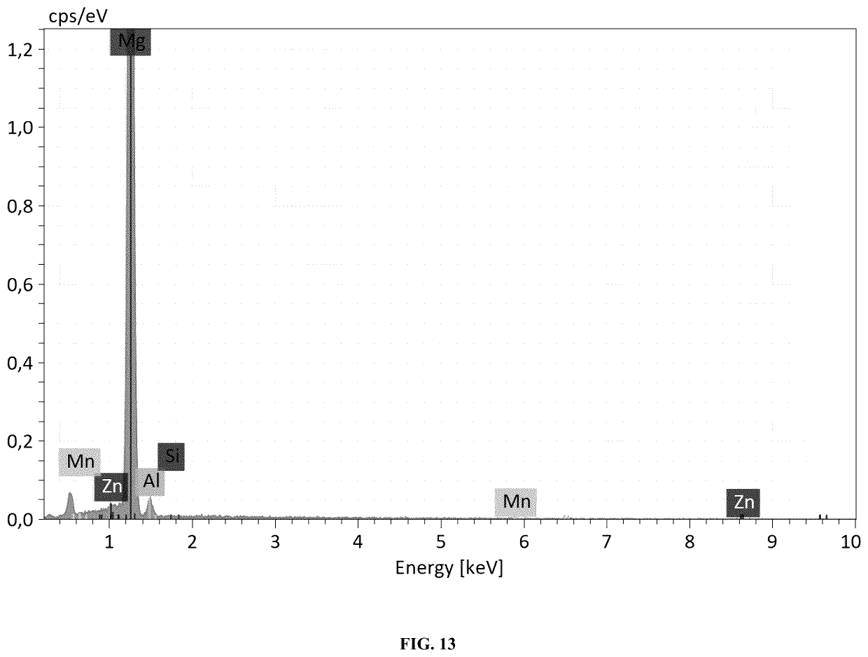

EDX was performed using a Zeiss Gemini Ultra-55 analytical field emission scanning electron microscope, equipped with a Bruker XFlash® 6|60 detector. A 300-second integration time was used at three separate points on each sample. The measured weight percents were then averaged to determine the final sample composition. FIG. 13 is an EDX spectrum of magnesium alloy AZ31B foil. According to FIG. 13, the AZ31B alloy foil composition is calculated as 96.3 wt % Mg, 3.1 wt % Al, and 0.6 wt % Zn.

### Example 11: Single-Layer Pouch Cell Made with Aluminum, Copper, and Magnesium Alloys as Negative-Electrode Current Collectors

Single-layer pouch cells with lithium iron phosphate positive electrodes and graphite negative electrodes, and with various magnesium alloy foils, a copper foil, or an aluminum foil negative-electrode current collectors were fabricated to verify the long-term performance after repeated cycles.

Each magnesium alloy foil was rolled down to 35 microns. In the case of the AZ31B alloy, XRD results are shown in FIG. 12 (see Example 10), EDX results are shown in FIG. 13 (see Example 10), and electrochemical behavior is described in FIGS. 5 and 6 (see Examples 4 and 5).

The surface morphology of the magnesium alloy foils, the copper foil, and the aluminum foil are shown in Table 3. The magnesium alloy AZ31B foil and the copper foils have Rₐ from 0.24-0.40 m, which is consistent with electrodeposited copper foils.

TABLE 3
Surface Roughness of Metal Foils in Example 11

| | Thickness | Side 1 | | | Side 2 | | |
|---|---|---|---|---|---|---|---|
| Material | (μm) | Rₐ (μm) | R_{z} (μm) | R_{q} (μm) | Rₐ (μm) | R_{z} (μm) | R_{q} (μm) |
| Copper A | 6 | 0.33 | 1.61 | 0.38 | 0.27 | 1.55 | 0.33 |
| Copper B | 10 | 0.23 | 1.37 | 0.29 | 0.26 | 1.43 | 0.31 |
| Aluminum | 12 | 0.09 | 0.59 | 0.11 | 0.10 | 0.64 | 0.12 |
| AZ31B | 35 | 0.24 | 1.65 | 0.30 | 0.30 | 2.06 | 0.38 |
| AZX211 | 100 | 0.17 | 1.09 | 0.21 | 0.16 | 1.16 | 0.20 |
| LZ141 | 35 | 0.36 | 2.06 | 0.43 | 0.33 | 2.19 | 0.42 |

Coated lithium iron phosphate (LFP) positive electrodes were purchased with a surface area normalized capacity of 1.69 mAh/cm², with a coating surface density of 12.3 mg/cm² coated on 14 μm carbon-coated aluminum foil. The active material percentage of the positive electrode was 91.5 wt %, with the remainder consisting of conductive additive and PVDF binder. For graphite negative electrodes, 92 wt % artificial graphite (MSE Supplies), 2% C-NERGY Super C65 Carbon Black, and 6% PVDF were mixed with N-methyl-2-pyrrolidone (NMP) to form a slurry which was then coated onto current-collector foils using a doctor blade to achieve a target areal loading of 1.86 mAh/cm² for a target n:p ratio of 1.1.

After coating, electrodes were dried at 100° C. until completely dry. Graphite electrodes were then calendered using a desktop calendering (roller press) machine to densify by a 30% reduction in electrode thickness to improve density and mechanical properties. After drying and calendering, the graphite negative electrodes were punched to size using a precision steel rule die to form 20 mm×21 mm rectangular electrodes (not including a 4 mm×5 mm uncoated tab area). The LFP positive electrodes were punched to form 18×19 mm rectangular electrodes (not including a 4 mm×5 mm uncoated tab area). The electrodes were sized with a negative electrode overhang of 1 mm around the perimeter to improve manual stacking alignment and to minimize the chances of unwanted lithium plating. Negative electrodes were joined to 0.1 mm thick, 4 mm wide nickel tabs by ultrasonic welding using a TMAX VS-40A 40 kHz 2 kW Ultrasonic Welding Machine. Positive electrodes were joined to 0.1 mm thick, 4 mm wide aluminum tabs by ultrasonic welding.

The cell stack was assembled by placing the cathode, a porous polypropylene separator, and the anode in an aluminum-laminate material pouch. The cells were then dried under vacuum at 100° C. for 16 hours to eliminate trace moisture and oxygen before transferring into an argon-filled glovebox (<1 ppm O₂, <0.1 ppm H₂O). The dried pouch cells were filled with electrolyte and heat-sealed under vacuum. The electrolyte consisted of 1.2 M LiPF₆ salt dissolved in a mixture of three parts ethylene carbonate (EC) to seven parts ethyl methyl carbonate (EMC) by weight, with an additional 2 wt % vinylene carbonate (VC) as an additive. After filling and sealing, the cells were removed from the glovebox and placed under light compression (11 psi) to keep electrodes in contact and rested for 8 hours before testing.

Filled cells then underwent formation cycles consisting of 2 cycles of constant-current/constant-voltage charge and constant-current discharge at a rate of C/10, with a lower voltage cutoff of 2.5 V and an upper voltage cutoff of 3.65 V in an environmental chamber held at 25° C. Cells were then cycled under constant-current/constant-voltage charge and constant-current discharge at a rate of 1 C, with a lower voltage cutoff of 2.5 V and an upper voltage cutoff of 3.65 V in an environmental chamber held at 25° C. Every 100 cycles, one C/10 charge-discharge cycle was performed to evaluate the C/10 capacity.

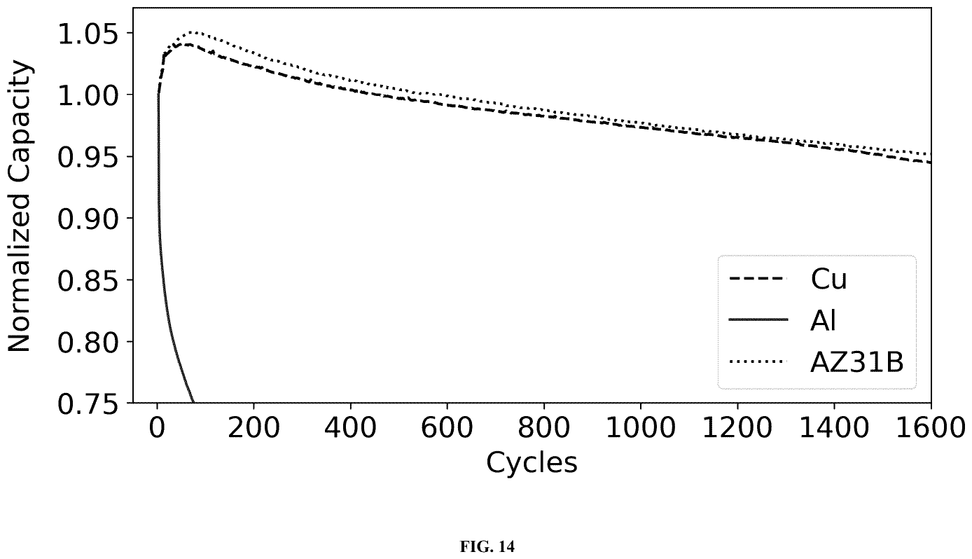

Single-layer pouch cells were assembled using 10 μm battery-grade copper, 12 μm battery-grade aluminum, and 35 μm magnesium alloy AZ31B foils as current collectors. Capacity retention as a function of cycle life is plotted in FIG. 14. The 1 C discharge cell-capacity retention after 1000 cycles was 97.3% for copper (dashed line) and 97.7% for AZ31B (dotted line) current collectors at room temperature.

These results clearly indicate that magnesium alloy foils can replace copper foil as negative-electrode current collectors in lithium-ion batteries. In contrast, cells using aluminum foil (solid line) rapidly fail due to damage to the underlying current collector. In this example, the lithium-ion battery preferably is substantially copper-free.

Table 4 shows the elemental composition of the magnesium alloy AZ31B current collector obtained by inductively coupled plasma-optical emission spectrometry (ICP-OES). Analysis shows that the current collector contains <50 ppm copper.

TABLE 4
ICP-OES Analysis of Substantially Copper-Free
Magnesium Alloy Current Collector AZ31B

| | Units | |
|---|---|---|
| Element | (by weight) | AZ31B |
| Mg | % | Bal. |
| Al | % | 3.54 |
| Zn | % | 0.67 |
| Mn | % | 0.33 |
| Si | ppm | 182 |
| Ca | ppm | 43.5 |
| Cu | ppm | 30.9 |
| Li | ppm | <100 |
| Fe | ppm | <10 |
| Ni | ppm | <9 |
| Zr | ppm | <5 |

### Example 12: Coin Cells Made with Magnesium Alloy or Copper Negative-Electrode Current Collectors

Coin (button) cells were fabricated using a standard CR2032 form factor consisting of a 20 mm diameter by 3.2 mm tall stainless steel can. Cells were composed of lithium iron phosphate positive electrodes on aluminum foil as positive-electrode current collectors, and graphite negative electrodes with magnesium alloy or copper foil as negative-electrode current collectors. Cells were fabricated to verify the performance of different magnesium alloys after repeated cycling.

In this example, the magnesium alloy foils were AZ31B alloy rolled down to 35 microns, AZX211 rolled down to 100 microns, and LZ141 rolled down to 50 microns. Bulk ZK60 was also tested after rolling an alloy sheet from 2 mm to 450 microns thick. The alloys can be identified by XRD, EDX, and ICP-OES, among other spectroscopic methods. The surface morphologies of the magnesium alloys and copper foils are summarized in Table 3 (cf. Example 11). The magnesium alloy foils have a Rₐ from 0.16 to 0.4, which is consistent with electrodeposited copper.

Coated lithium iron phosphate (LFP) positive electrodes were purchased with a surface-area-normalized capacity of 1.69 mAh/cm², with a coating surface density of 12.3 mg/cm² coated on 14 μm carbon-coated aluminum foil. The active material percentage of the positive electrode was 91.5 wt %, with the remainder consisting of conductive additive and PVDF binder. For graphite negative electrodes, 92 wt % artificial graphite (MSE Supplies), 2 wt % C-NERGY Super C65 Carbon Black, and 6 wt % PVDF (Kureha) were mixed with N-methyl-2-pyrrolidone to form a slurry which was then coated onto current-collector foils using a doctor blade to achieve target areal loading of 1.86 mAh/cm² for a target n:p ratio of 1.1.

After coating, electrodes were dried at 100° C. until completely dry. Graphite electrodes were then calendered using a desktop calendering (roller press) machine to densify by a 30% reduction in electrode thickness to improve density and mechanical properties. After drying and calendering, the graphite negative electrodes were punched to size using a precision die to form 15-mm-diameter circular electrodes. The electrodes were sized with a negative electrode overhang of 1 mm around the perimeter to improve manual stacking alignment and to minimize the chances of unwanted lithium plating. Electrode and cell components were dried under vacuum at 100° C. for 16 hours before transferring into an argon-filled glovebox (<1 ppm O₂, <0.1 ppm H₂O).

A cell stack was assembled by placing the negative electrode, a porous polypropylene separator, and the positive electrode with electrolyte solution added between each layer for a total volume of 45 μL of electrolyte. Stainless steel spacers and a conical spring inside a CR2032 can which was subsequently crimped provide a hermetic seal from the outside environment. The electrolyte consisted of 1.2 M LiPF₆ salt dissolved in a mixture of three parts ethylene carbonate to seven parts ethyl methyl carbonate by weight, with an additional 2 wt % vinylene carbonate as an additive. After sealing, cells were removed from the glovebox and rested for 8 hours before testing.

Coin cells then underwent formation cycles consisting of 2 cycles of constant-current/constant-voltage charge and constant-current discharge at a rate of C/10 with a lower voltage cutoff of 2.5 V and an upper voltage cutoff of 3.65 V in an environmental chamber held at 25° C. Cells were then cycled under constant-current/constant-voltage charge and constant-current discharge at a rate of 1 C, with a lower voltage cutoff of 2.5 V and an upper voltage cutoff of 3.65 V in an environmental chamber held at 25° C. Every 50 cycles, one C/10 charge-discharge cycle was performed to evaluate the C/10 capacity.

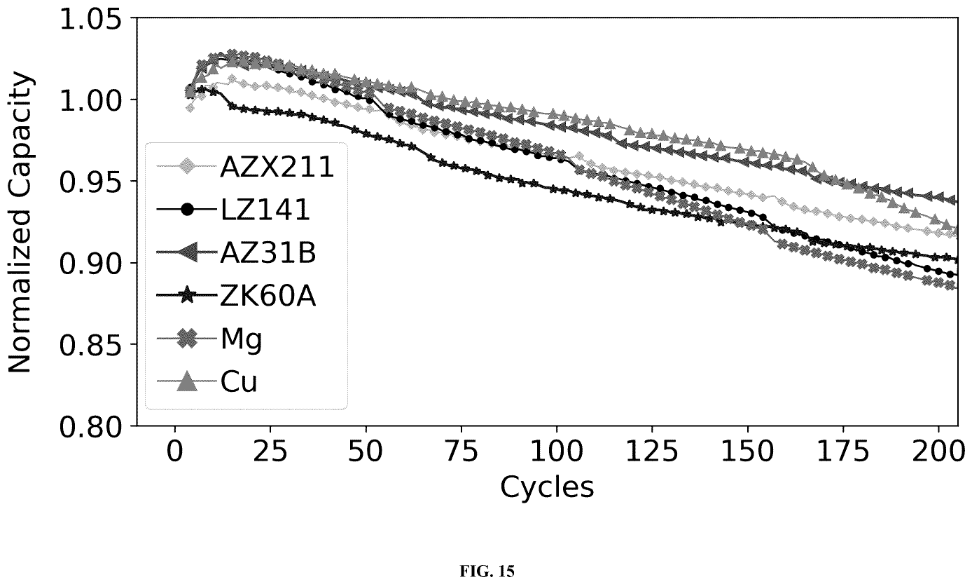

Capacity retention as function of cycle life in a lithium-ion coin cell is plotted in FIG. 15. The 1 C discharge capacity retention after 200 cycles was 92.3% for copper (upward triangles), 91.7% for AZX211 (diamonds), 89.2% for LZ141 (circles), 93.9% for AZ31B (left triangles), and 90.3% for ZK60A (stars) current-collector cells at 25° C.

These results clearly indicate that magnesium alloy foils can replace copper foil as negative-electrode current collectors in lithium-ion batteries. These results further indicate that the performance of the negative-electrode current collector can be tuned by varying the alloying components and their elemental amounts in the magnesium alloy foil.

### Example 13: Pure Magnesium Foil as Current Collector

In this example, a 99.99 wt % pure magnesium foil rolled down to 100 microns is used as the negative-electrode current collector in a coin cell. The surface morphologies of the magnesium foil is summarized in Table 3 (cf. Example 11). The pure magnesium foil has a Rₐ from 0.16 to 0.4, which is consistent with electrodeposited copper.

A coin (button) cell was fabricated using a standard CR2032 form factor consisting of a 20 mm diameter by 3.2 mm tall stainless steel can. The cell was composed of lithium iron phosphate positive electrode on aluminum foil as the positive-electrode current collector, and a graphite negative electrode with pure magnesium as the negative-electrode current collector. The cell was fabricated to verify the performance of pure magnesium after repeated cycling.

A coated lithium iron phosphate (LFP) positive electrode was purchased with a surface-area-normalized capacity of 1.69 mAh/cm², with a coating surface density of 12.3 mg/cm² coated on 14 μm carbon-coated aluminum foil. The active material percentage of the positive electrode was 91.5 wt %, with the remainder consisting of conductive additive and PVDF binder. For the graphite negative electrode, 92 wt % artificial graphite (MSE Supplies), 2 wt % C-NERGY Super C65 Carbon Black, and 6 wt % PVDF (Kureha) were mixed with N-methyl-2-pyrrolidone to form a slurry which was then coated onto the Mg current-collector foil using a doctor blade to achieve target areal loading of 1.86 mAh/cm² for a target n:p ratio of 1.1.

After coating, the electrode was dried at 100° C. until completely dry. The graphite electrode was then calendered using a desktop calendering (roller press) machine to densify by a 30% reduction in electrode thickness to improve density and mechanical properties. After drying and calendering, the graphite negative electrode was punched to size using a precision die to form a 15-mm-diameter circular electrode. The electrode was sized with a negative electrode overhang of 1 mm around the perimeter to improve manual stacking alignment and to minimize the chances of unwanted lithium plating. Electrode and cell components were dried under vacuum at 100° C. for 16 hours before transferring into an argon-filled glovebox (<1 ppm O₂, <0.1 ppm H₂O).

A cell stack was assembled by placing the negative electrode, a porous polypropylene separator, and the positive electrode with electrolyte solution added between each layer for a total volume of 45 μL of electrolyte. Stainless steel spacers and a conical spring inside a CR2032 can which was subsequently crimped provide a hermetic seal from the outside environment. The electrolyte consisted of 1.2 M LiPF₆ salt dissolved in a mixture of three parts ethylene carbonate to seven parts ethyl methyl carbonate by weight, with an additional 2 wt % vinylene carbonate as an additive. After sealing, cells were removed from the glovebox and rested for 8 hours before testing.

The coin cell then underwent formation cycles consisting of 2 cycles of constant-current/constant-voltage charge and constant-current discharge at a rate of C/10 with a lower voltage cutoff of 2.5 V and an upper voltage cutoff of 3.65 V in an environmental chamber held at 25° C. The cells was then cycled under constant-current/constant-voltage charge and constant-current discharge at a rate of 1 C, with a lower voltage cutoff of 2.5 V and an upper voltage cutoff of 3.65 V in an environmental chamber held at 25° C. Every 50 cycles, one C/10 charge-discharge cycle was performed to evaluate the C/10 capacity.

Capacity retention as function of cycle life in a lithium-ion coin cell is plotted in FIG. 15. The 1 C discharge capacity retention after 200 cycles was 88.7% for the magnesium (×symbols) current-collector cell at 25° C. The capacity retention for substantially pure magnesium is similar to that for LZ141 magnesium alloy in FIG. 15 (cf. Example 12).

These results indicate that pure-magnesium foils can replace copper foil as negative-electrode current collectors in lithium-ion batteries in some embodiments.

### Example 14: Magnesium Alloy Foils as Electrochemically Stable Positive-Electrode Current Collectors

This example demonstrates a magnesium alloy used as the positive-electrode current collector, rather than the negative-electrode current collector. The magnesium alloy in this example is AZ31B.

Cyclic voltammetry is an electrochemical technique which is useful in determining the electrochemical stability of a material. Cyclic voltammetry is a potentiodynamic, electrochemical measurement technique performed with a potentiostat (e.g., Biologic VMP3) in which a working electrode's potential is ramped linearly versus time between two voltage limits in both forward and reverse directions, while monitoring the resulting current. The resulting current-potential plot (cyclic voltammogram) exhibits characteristic peaks corresponding to oxidation and reduction processes, providing information about electrochemical reaction reversibility, reaction mechanisms, and electron-transfer kinetics. Peak positions and distances reveal thermodynamic and kinetic information about the electrochemical processes in the system. Cyclic voltammetry allows for investigation into the electrochemical stability for base-metal current-collector systems.

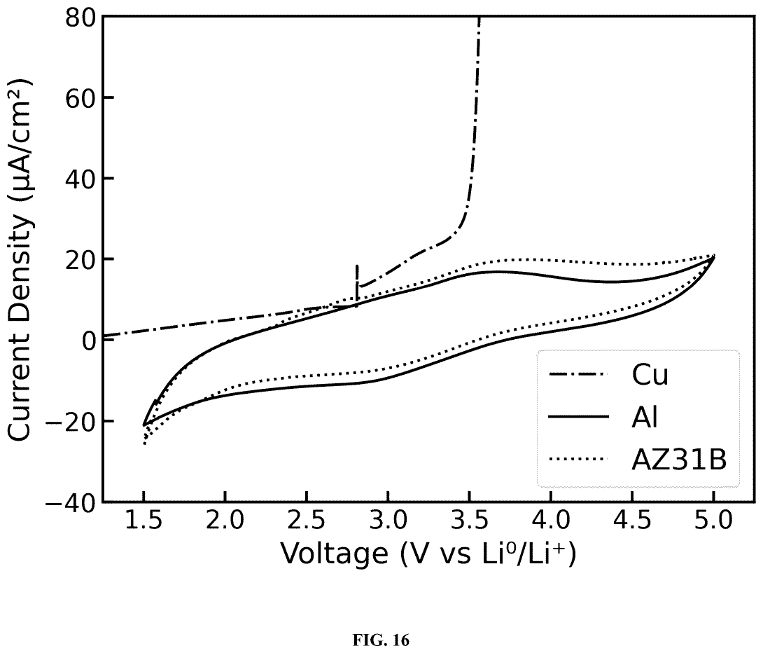

To conduct cyclic-voltammetry experiments in this example, current-collector foil versus lithium metal Swagelok-style half cells were constructed. The electrolyte used in the cells was 1.2 M LiPF₆ in EC and EMC (3:7 gravimetric ratio). Cyclic voltammetry sweeps were conducted between 1.5 V and 5 V at a scan rate of 2 mV/s. The voltage limits were selected to be similar to the experienced operational range of positive-electrode current collectors within a lithium-ion battery. For copper current collectors, only a single (linear) voltammetry sweep was conducted, because copper rapidly oxidizes, releasing soluble Cu²⁺ species at potentials above ~3.2 V vs. Li⁰/Li⁺. The results of the cyclic-voltammetry experiments are shown in FIG. 16.

While copper foil is a good negative-electrode current collector due to its electrochemical stability at low potentials, copper cannot be used as a positive-electrode current collector in a lithium-containing battery due to its poor oxidative stability at positive-electrode operating voltages as exemplified by the large current spike around 3.5 V vs. Li⁰/Li⁺ in the cyclic voltammogram plotted in FIG. 16.

Aluminum, on the other hand, has good oxidative stability up to 4.5 V vs. Li⁰/Li⁺ as exemplified by the stable current density between 3.5 V and 4.5 V vs. Li⁰/Li⁺ plotted in FIG. 16. This is why aluminum foil is the most commonly used positive-electrode current collector in lithium-ion systems.

Magnesium alloy foils can serve as positive-electrode current collectors in lithium-ion systems, with good oxidative stability similar to aluminum up to 4.5 V vs. Li⁰/Li⁺ as shown by the stable current density between 3.5 and 4.5 V vs. Li⁰/Li⁺ plotted in FIG. 16. This result, in conjunction with previous examples, enables magnesium alloys to be used as both negative-electrode and positive-electrode current collectors.

In this detailed description, reference has been made to multiple embodiments and to the accompanying drawings in which are shown by way of illustration specific exemplary embodiments of the technology. These embodiments are described in sufficient detail to enable those skilled in the art to practice the technology, and it is to be understood that modifications to the various disclosed embodiments may be made by a skilled artisan.

Where methods and steps described above indicate certain events occurring in certain order, those of ordinary skill in the art will recognize that the ordering of certain steps may be modified and that such modifications are in accordance with the variations of the technology. Additionally, certain steps may be performed concurrently in a parallel process when possible, as well as performed sequentially.

All publications, patents, and patent applications cited in this specification are herein incorporated by reference in their entirety as if each publication, patent, or patent application were specifically and individually put forth herein.

The embodiments, variations, and figures described above should provide an indication of the utility and versatility of the present technology. Other embodiments that do not provide all of the features and advantages set forth herein may also be utilized, without departing from the spirit and scope of the technology. Such modifications and variations are considered to be within the scope of the technology defined by the claims.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. It will be apparent to one of skill in the art how alternative functional, logical, or physical partitioning and configurations can be implemented to implement the desired features of the technology disclosed herein. Additionally, with regard to operational descriptions and methods, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the other embodiments of the disclosed technology, whether or not such features are presented as being a part of a described embodiment. Thus, the breadth and scope of the technology disclosed herein should not be limited by any of the exemplary embodiments, but only by the claims.

What is claimed is:

1. A lithium-ion battery comprising:
(a) a negative electrode;
(b) a negative-electrode current collector in contact with said negative electrode;
(c) a lithium-containing electrolyte;
(d) a separator interposed between said negative electrode and said positive electrode, wherein said separator is permeable to lithium ions;
(e) a positive electrode; and
(f) a positive-electrode current collector in contact with said positive electrode,
wherein said negative-electrode current collector comprises a magnesium alloy foil containing at least 50 atomic percent magnesium.

2. The lithium-ion battery of claim 1, wherein said negative-electrode current collector consists essentially of said magnesium alloy foil.

3. The lithium-ion battery of claim 1, wherein said magnesium alloy foil has a thickness selected from about 4 μm to about 50 μm.

4. The lithium-ion battery of claim 1, wherein said magnesium alloy foil has an average roughness Rₐ selected from about 0.05 μm to about 2 μm.

5. The lithium-ion battery of claim 1, wherein said magnesium alloy foil has a surface roughness R_{z} selected from about 0.25 μm to about 3 μm.

6. The lithium-ion battery of claim 1, wherein said magnesium alloy foil contains from 50 atomic percent magnesium to 99.8 atomic percent magnesium.

7. The lithium-ion battery of claim 1, wherein said magnesium alloy foil further comprises aluminum, copper, lithium, manganese, zinc, calcium, zirconium, silver, yttrium, cerium, lanthanum, or a combination thereof.

8. The lithium-ion battery of claim 1, wherein said magnesium alloy foil further comprises from about 0.25 to about 15 weight percent aluminum.

9. The lithium-ion battery of claim 1, wherein said magnesium alloy foil further comprises from about 0.25 to about 10 weight percent zinc.

10. The lithium-ion battery of claim 1, wherein said magnesium alloy foil further comprises from about 0.25 to about 10 weight percent calcium.

11. The lithium-ion battery of claim 1, wherein said magnesium alloy foil further comprises from about 1 to about 20 weight percent lithium.

12. The lithium-ion battery of claim 1, wherein said negative-electrode current collector is substantially copper-free.

13. The lithium-ion battery of claim 1, wherein said lithium-ion battery is substantially copper-free.

14. The lithium-ion battery of claim 1, wherein said magnesium alloy foil contains a magnesium alloy selected from the group consisting of AJ52A, AJ62A, AM50A, AM60A, AM60B, AM100A, AMX602, AS41A, AZ31B, AZ31C, AZ31D, AZ61A, AZ63A, AZ63B, AZ63C, AZ63D, AZ80A, AZ81A, AZ91A, AZ91B, AZ91C, AZ91D, AZ91E, AZ92A, AZ101A, AZX111, AZX211, AZX311, K1A, LA21, LA41, LA61, LA91, LA141, LZ21, LZ41, LZ61, LZ91, LZ141, LAZ941, M1A, ZC63A, ZE41A, ZEK100, ZK40A, ZK51A, ZK60A, ZK61A, and combination thereof.

15. The lithium-ion battery of claim 1, wherein said magnesium alloy foil is a rolled foil.

16. The lithium-ion battery of claim 1, wherein said magnesium alloy foil has an areal capacity from about 2 to about 250 μAh/cm² at a foil thickness of about 4 μm to about 50 μm or less when biased at 20 mV vs Li⁰/Li⁺ for 12 hours.

17. The lithium-ion battery of claim 1, wherein said magnesium alloy foil has a bulk electrical resistivity from about 5 to about 25 μΩ-cm.

18. The lithium-ion battery of claim 1, wherein said magnesium alloy foil has an ultimate tensile strength greater than 150 MPa.

19. The lithium-ion battery of claim 1, wherein said magnesium alloy foil has an elongation to fracture greater than 0.5%.

20. The lithium-ion battery of claim 1, wherein said lithium-ion battery comprises an electrode/separator stack containing said negative electrode, said separator, and said positive electrode.

21. The lithium-ion battery of claim 1, wherein said negative-electrode current collector is joined to a conductive metal body via ultrasonic welding, laser welding, or an adhesive, or wherein said negative-electrode current collector is mechanically joined to said conductive metal body.

22. The lithium-ion battery of claim 1, said negative-electrode current collector is joined to a body material comprising an additional magnesium alloy.

23. The lithium-ion battery of claim 1, said negative-electrode current collector is joined to a body material comprising aluminum, an aluminum alloy, iron, steel, stainless steel, nickel, copper, zinc, a zinc alloy, or a combination thereof.

24. The lithium-ion battery of claim 1, wherein said positive-electrode current collector comprises a second magnesium alloy foil, and wherein said second magnesium alloy foil contains at least 50 atomic percent magnesium.

25. The lithium-ion battery of claim 24, wherein said second magnesium alloy foil is compositionally the same as said magnesium alloy foil.

26. A sealed lithium-ion battery comprising said lithium-ion battery of claim 1, wherein said sealed lithium-ion battery further comprises a battery casing that sealably encloses said lithium-ion battery from the environment.

27. The lithium-ion battery of claim 1, wherein said negative electrode comprises graphite, silicon, lithium titanate, metallic lithium, or a combination thereof.

28. The lithium-ion battery of claim 1, wherein negative electrode material is mixed in a solvent and deposited onto said magnesium alloy foil.

29. The lithium-ion battery of claim 1, wherein negative electrode material is deposited via a dry process.

30. The lithium-ion battery of claim 1, wherein said electrolyte is a liquid, a solid, a semi-solid, a gel, or a combination thereof.
